(19) United States
(12) Patent Application Publication
(10) Pub. No.: US 2019/0034108 A1
(43) Pub. Date: Jan. 31, 2019

(54) PRIVATE ACCESS TO MEDIA DATA ON NETWORK STORAGE

(71) Applicant: SPATIAL DIGITAL SYSTEMS, INC., Agoura Hills, CA (US)

(72) Inventors: Donald C.D. Chang, Thousand Oaks, CA (US); Juo-Yu Lee, Westlake Village, CA (US); Steve K. Chen, Pacific Palisades, CA (US)

(73) Assignee: SPATIAL DIGITAL SYSTEMS, INC., Agoura Hills, CA (US)

(21) Appl. No.: 16/133,699

(22) Filed: Sep. 18, 2018

Related U.S. Application Data
(63) Continuation-in-part of application No. 14/935,312, filed on Nov. 6, 2015, now Pat. No. 10,079,886.
(60) Provisional application No. 62/207,032, filed on Aug. 19, 2015.

(51) Int. Cl. G06F 3/06; H04B 7/08; H04B 7/06; G06F 17/30

(52) U.S. Cl. CPC G06F 3/0638; G06F 3/0661; G06F 3/067; H04L 67/06; H04B 7/086; H04B 7/0617; G06F 17/30017; G06F 3/062

(57) ABSTRACT

A pre-processing apparatus includes a segmenter, a wavefront multiplexing (WFM) processor, and a network interface. The segmenter segments a media file or a plurality of media files into N media components using a data formatting scheme. The WFM processor transforms the N media components to N transformed components on a sample basis or a block basis according to the data formatting scheme. Each of the N transformed components is a linear combination of the N media components. The network interface transmits the N transformed components to a server for storage as a document file on a remote storage via a network connectivity.

### RELATED APPLICATIONS

This application, as a continuation-in-part (CIP), claims priority to the U.S. non-provisional patent application No. 14/935,312 filed on Nov. 6, 2015, which claims priority to U.S. provisional application No.62,207,032 filed on Aug. 19, 2015. Both of which are incorporated herein by reference in their entireties.

### TECHNICAL FIELD

The presently disclosed embodiments are directed to the field of data protection for network storage. In particular, the embodiments are directed to private access to media data on network storage using wavefront multiplexing (WFM) technology.

### BACKGROUND

Advances in information, security, communication, and storage technologies have created demands for efficient communication and storage. Mobile computing, hand-held devices, network storage and cloud computing technologies have been developed to meet these demands for high capacity, secure, and fast data transmission, retrieval, and storage.

In addition to the above computing technologies, social media technologies have also been developed at a fast rate to accommodate demands in human communication and interactions. Social media are computer-mediated technologies that facilitate the creation and sharing of information, ideas, career interests and other forms of expression via virtual communities and networks. One of the most important personal information exists in form of media such as images, video, or audio. Facebook, YouTube, Instagram are examples of popular social media that allows sharing images, live streams, or video clips.

Communication of personal media has also been facilitated by advances in mobile computing. Mobile computing is humancomputer interaction by which a computer is expected to be transported during normal usage, which allows for transmission of data, voice and video. Mobile computing involves mobile communication, mobile hardware, and mobile software. The most common forms of mobile computing devices include hand-held devices such as smart phones, personal digital assistants (PDAs), portable computers (e.g., laptops, notebooks), tablets, wearable computers, etc. Due to their usage models, mobile computing requires low weight, low power consumption, and good interactive performance. Therefore, data storage is typically reduced within the mobile devices to satisfy weight, power, and cost constraints. For this reason, storage for mobile devices is typically performed through some form of storage via a network connectivity.

Two types of network storage are currently available: network-attached storage and cloud storage. Network-attached storage (NAS) is a file-level computer data storage server connected to a computer network providing data access to a heterogeneous group of clients. NAS systems are networked appliances which contain one or more storage drives, often arranged into logical, redundant storage containers or redundant array of independent disks (RAIDs). NAS may be implemented as open-source servers or clustered systems. In contrast, cloud storage is a model of data storage in which the digital data is stored in logical pools, the physical storage spans multiple servers (and often locations), and the physical environment is typically owned and managed by a hosting company. Cloud storage is based on highly virtualized infrastructure and has many useful features such as easy accessible interfaces, near-instant elasticity and scalability, multi-tenancy, and metered resources. Cloud storage services can be utilized from an off-premises service, such as Amazon S3, or deployed on-premises such as ViON Capacity Services. A cloud storage system maintains copies of digital data across a unified architecture of servers and data centers. It is designed to back up files, databases and applications to a central location that can easily be accessed via standard network protocols and tools. Besides freeing up local storage space, cloud storage systems can copy data from a primary source to a secure data center or on-premises environment.

A NAS provides a space for the whole local network and usually finds its place in local sites. With the ability to store and share data, most NAS devices can also run as servers for a Web site for example. In contrast, cloud storage is renting up a space from a provider. Depending on the applications, budgets, security options, a user selects a NAS or cloud storage accordingly.

Security on data storage and transport are important concerns on network storage. Viruses, intrusions, malware, and threats have become pervasive at an alarming rate. Threats to network security come in the form of intrusions or attacks by people interested in information theft or destruction. These security attacks cause numerous damages including financial losses, information theft, service interruptions, invasion of privacy, etc.

### SUMMARY

One disclosed feature of the embodiments is a method and apparatus to generate a document file to be stored on a remote storage. A segmenter segments a media file or a plurality of media files into N media components using a data formatting scheme. A wavefront multiplexing (WFM) processor transforms the N media components to N transformed components on a sample basis or a block basis according to the data formatting scheme. Each of the N transformed components is a linear combination of the N media components. A network interface transmits the N transformed components to a server for storage as a document file on a remote storage via a network connectivity.

Another disclosed feature of the embodiments is a method and apparatus to recover a media file or a plurality of media files from a document file retrieved from a remote storage. A network interface receives a document file including N transformed components from a remote storage via a network connectivity. A wavefront de-multiplexing (WFD) processor transforms the N transformed components to N media components on a sample basis or a block basis according to a data formatting scheme. Each of the N media components is a linear combination of the N transformed components. A de-segmenter de-segments the N media components into a media file or a plurality of media files using the data formatting scheme.

### BRIEF DESCRIPTION OF THE DRAWINGS

Embodiments may best be understood by referring to the following description and accompanying drawings that are used to illustrate embodiments. In the drawings:

FIG. 1 is a diagram illustrating a system having an 8-to-8 preprocessor at a transmitter side and network servers according to one embodiment.

FIG. 2 is a diagram illustrating a segmenter according to one embodiment.

FIG. 3 is a diagram illustrating a WFM device according to one embodiment.

FIG. 4 is a diagram illustrating a 4-to-4 preprocessor according to one embodiment.

FIG. 5 is a diagram illustrating an 8-to-8 postprocessor at a receiver side and network servers according to one embodiment.

FIG. 6 is a diagram illustrating a WFD device according to one embodiment.

FIG. 7 is a diagram illustrating a de-segmenter according to one embodiment.

FIG. 8 is a diagram illustrating a mobile device using WF muxing according to one embodiment.

FIG. 9 is a diagram illustrating a mobile device using WF de-muxing according to one embodiment.

FIG. 10 is a diagram illustrating a system using mobile devices with WF muxing and de-muxing according to one embodiment.

FIG. 11 is a diagram illustrating a system using a mobile device with WF muxing and 3-for-4 redundancy according to one embodiment.

FIG. 12 is a diagram illustrating a system using a mobile device with WF de-muxing and 3-for-4 redundancy according to one embodiment.

FIG. 13 is a diagram illustrating a system using mobile devices with WF muxing and de-muxing and 3-for-4 redundancy according to one embodiment.

FIG. 14 is a diagram illustrating a system using mobile devices with WF muxing and de-muxing and 3-for-4 redundancy according to one embodiment.

FIG. 15 is a diagram illustrating a simplified system using mobile devices with WF muxing and de-muxing and 3-for-4 redundancy according to one embodiment.

FIG. 16 is a diagram illustrating a WFD device according to one embodiment.

FIG. 17 is a diagram illustrating a system having multiple media inputs and using mobile devices with WF muxing and de-muxing and 3-for-4 redundancy according to one embodiment.

FIG. 18 is a diagram illustrating a system having multiple media inputs at the transmitter side and multiple media outputs at the receiver side and using mobile devices with WF muxing and de-muxing and 3-for-4 redundancy according to one embodiment.

FIG. 19 is a diagram illustrating a processing device using a polynomial for generating Reed-Solomon (RS) code as a K muxing process with multiple media input files according to one embodiment.

FIG. 20 is a diagram illustrating outputs as linear combinations of inputs according to one embodiment.

FIG. 21 is a diagram illustrating a processing device using a polynomial for generating Reed-Solomon (RS) code as a K muxing process with multiple media input files having one grounded input according to one embodiment.

FIG. 22 is a diagram illustrating a processing device using a polynomial for generating Reed-Solomon (RS) code as a K muxing process with multiple media input files having one auxiliary input according to one embodiment.

FIG. 23 is a diagram illustrating a processing device using a polynomial for generating Reed-Solomon (RS) code as a K muxing process with multiple media input files in complex number format according to one embodiment.

FIG. 24 is a diagram illustrating geometry of an array forming multiple beams according to one embodiment.

FIG. 25 is a diagram illustrating array gain vs. azimuth angle for four radiation patterns according to one embodiment.

FIG. 26 is a diagram illustrating geometry of an array forming multiple beams via Butler matrices according to one embodiment.

FIG. 27 is a diagram illustrating far field radiation patterns according to one embodiment.

FIG. 28 is a diagram illustrating a functional diagram of a 4-to-4 Butler matrix according to one embodiment.

FIG. 29 is a diagram illustrating a functional diagram of a 4-to-4 Butler matrix with phase biasing according to one embodiment.

FIG. 30 is a diagram illustrating an erasure code (EC) polynomial for K muxing function according to one embodiment.

FIG. 31 is a diagram illustrating a processing device using a polynomial for generating Reed-Solomon (RS) code as a K muxing process with multiple media record files according to one embodiment.

FIG. 32 is a diagram illustrating a processing device according to one embodiment.

FIG. 33 is a flowchart illustrating a process for K muxing according to one embodiment.

FIG. 34 is a flowchart illustrating a process for K de-muxing according to one embodiment.

### DETAILED DESCRIPTION

One disclosed feature of the embodiments is a technique to generate a document file to be stored on a remote storage. A segmenter segments a media file or a plurality of media files into N media components using a data formatting scheme. A wavefront multiplexing (WFM) processor transforms the N media components to N transformed components on a sample basis or a block basis according to the data formatting scheme. Each of the N transformed components is a linear combination of the N media components. A network interface transmits the N transformed components to a server for storage as a document file on a remote storage via a network connectivity.

Another disclosed feature of the embodiments is a method and apparatus to recover a media file or a plurality of media files from a document file retrieved from a remote storage. A network interface receives a document file including N transformed components from a remote storage via a network connectivity. A wavefront de-multiplexing (WFD) processor transforms the N transformed components to N media components on a sample basis or a block basis according to a data formatting scheme. Each of the N media components is a linear combination of the N transformed components. A de-segmenter de-segments the N media components into a media file or a plurality of media files using the data formatting scheme.

In the following description, numerous specific details are set forth. However, it is understood that embodiments may be practiced without these specific details. In other instances, well-known circuits, structures, and techniques have not been shown to avoid obscuring the understanding of this description. One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

Wavefront multiplexing/demultiplexing (WF muxing/demuxing) process embodies an architecture that utilizes multi-dimensional waveforms in cloud data storage and transport. Multiple data sets are preprocessed by WF muxing before stored/transported. WF muxed data is aggregated data from multiple data sets that have been “customized processed” and disassembled into any scalable number of sets of processed data, with each set being stored on a storage site. The original data is reassembled via WF demuxing after retrieving a lesser but scalable number of WF muxed data sets. In short, the WF muxed data storage solution enhances data security and data redundancy by, respectively, creating a new dimension to existing security/privacy methods and significantly reducing the storage space needed for data redundancy. In addition, WF muxing/demuxing methods enable a monitoring capability on the integrity of stored data.

Terminologies: K-space is also a well understood term in solid state physics and Imaging processing. The k-space can refer to: (1) Another name for the frequency domain but referring to a spatial rather than temporal frequency; (2) Reciprocal space for the Fourier transform of a spatial function; (3) Momentum space for the vector space of possible values of momentum for a particle; and (4) The k-space in magnetic resonance imaging (MRI), a formalism of k-space widely used in magnetic resonance imaging (MRI). In addition, in MRI physics, k-space is the 2D or 3D Fourier transform of the MR image measured.

The terms K-mux, Kmux, or KMx are used for the Wavefront multiplex; and K-muxing, Kmuxing, or KMxing are used for the wavefront multiplexing. In electromagnetic (EM) theory, the letter K is often used to represent a directional vector and is a wave number in a propagation direction. The term (ωt -K.R) has been used extensively for propagation phase. K represents a directional (moving) surface and R a directional propagation displacement. Therefore, K is a “wavefront” mathematically. K-space will be used as wavefront domain or wavefront space.

One disclosed aspect of the embodiments addresses enhanced privacy, reliability, and survivability of stored data, and data transports on cloud via wavefront multiplexing (WF muxing) or demultiplexing (demuxing) or K-muxing/demuxing methods and techniques. Since stored data on multiple sites is preprocessed on client sides, each of the stored data on network or cloud is a multiplexed (muxed) data set individually which is unintelligible by itself. Therefore, the proposed approaches remove the concerns on integrity confidence of operators, and those on the right of stored data. Camouflaged (image) cloud data storage and transport is one highlight of this application. Embodiments of “writing” and “reading” processes will be presented. “Writing” features a process on multiple original images concurrently via WF muxing transformations, generating WF muxed (image) data to be stored on cloud. A “reading” process corresponds to a WF demuxing transformation on WF muxed (image) data stored on cloud, reconstituting original (image) data sets.

Wavefront multiplexing/de-multiplexing (WF muxing/de-muxing) process features an algorithm for satellite communications where transmissions demand a high degree of power combining, security, reliability, and optimization. WF muxing/demuxing, embodying an architecture that utilizes multi-dimensional transmissions, has found applications in fields beyond the satellite communication domain. One such application is data storage on cloud where privacy, data integrity, and redundancy are important for both data transports and data storage. User devices include fixed desktop personal computers (PC), relocatable notebooks, and portable devices, including smart phones and smart tablets such as iPhone, and iPad.

A method for storing data in network storage (e.g., cloud storage) includes: transforming multiple first data sets into multiple second data sets at a transmitting site, wherein one of said second data sets includes a linear combination or a weighted sum of the first data sets; storing said second data sets in a network storage such as Internet Protocol (IP) cloud via the Internet; and storing multiple links linking to the second data sets at the transmitting site. In accordance with an embodiment, the method may include storing said second data sets at a receiving site via Internet in accordance with the links. Further, the method may include transforming the second data sets into multiple third data sets at a receiving site, wherein one of the third data sets comprises a weighted sum of the second data sets.

One disclosed aspect of the embodiments relates to distributed data storages with built-in redundancy for a single stream data subdivided into M multiple data substreams or M independent data streams, converted into a WF muxed domain (or a K-muxed domain) with M+N output wavefront components (wfcs), these M+N wfc output data being stored into M+N separated data storage sets, where N and M are integers and N>0. We may refer to the M original data streams as original value-data sets or simply value-data sets. As a result, the M+N stored-data sets are wavefront components in forms of linear combinations of the M original value-data sets, which are derivable from the M value-data sets themselves.

From a linear algebra point of view, it is adequate to use M stored-data sets to represent M value-data sets. However, if we use M+N stored-data sets to represent only M value-data sets, then there are opportunities to have N redundant stored-data sets among the total M+N stored-data sets; creating a M for M+N redundancy structure. We only require any M of the M+N stored-data sets to recover embedded M value-data sets, or N redundant stored data sets. In the following, embodiments may be described using M=4 or 8 for illustrative purposes. As is known by one skilled in the art, any integer number may be used as long as the basic properties of the K-muxing or K-de-muxing function, such as the use of orthogonal matrix, is maintained.

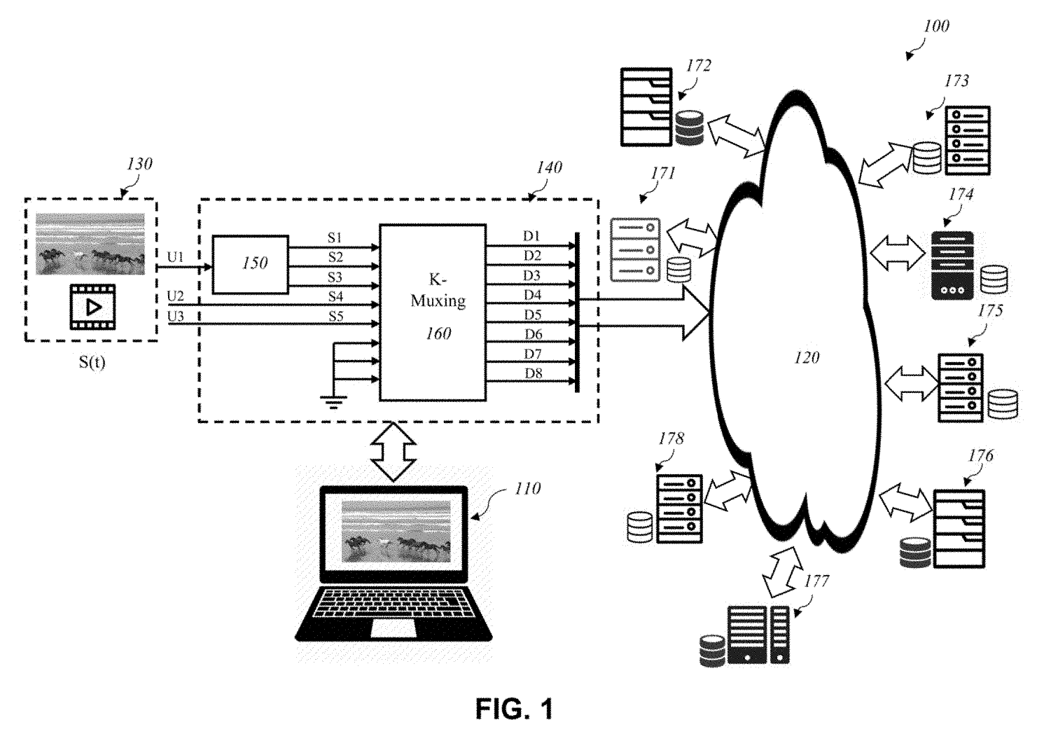

FIG. 1 is a diagram illustrating a system 100 having an 8-to-8 preprocessor at a transmitter side and network servers according to one embodiment. The system 100 includes a computing device 110 having a pre-processing functionality 140, a media input 130, a network 120, and a set of servers and storages 171, 172, 173, 174, 175, 176, 177, and 178.

The computing device 110 is any computing device including laptop, notebook, mobile devices, and specialized circuits that are capable of performing WF muxing/de-muxing or K muxing/de-muxing. The functionality 140 may be implemented as processing function in a computing element or a specialized circuit. It includes a segmenter 150 and a K-muxing function or device 160.

The media input 130 may be an image, a video clip, an audo clip, a graphic representation, a graphic sequence or animation, or any combination of the above. The media input 130 may belong to user U1. The segmenter segments the media input 130 into three inputs S1, S2, and S3. There are two other users U2 and U3 providing media inputs S4 and S5. The functionality 140 depicts a writing process to store 5 sets of data, S1, S2, S3, S4 and S5, in 8 physically separated data storage sites 171, 172, 173, 174, 175, 176, 177, and 178 connected through the network 120. The writing process features techniques of wavefront multiplexing (WF muxing or a K-muxing) performed by K muxing device 160. The 8-to-8 K-muxing function 160 features 8 inputs and 8 outputs. Three of the 8 inputs are grounded or are not used.

The network 120 may be any suitable network having wired or wireless connectivity. The network 120 may be a local area network (LAN), a wide area network (WAN), an intranet, or the Internet. The network 120 may also be configured for cloud networking which provides access of networking resources from a centralized third-party provider using WAN or Internet-based access technologies. The data storage sites 171, 172, 173, 174, 175, 176, 177, and 178 may include remote or network storages such as NAS storages or cloud storage. Cloud storage may be made up by many distributed resources. It is highly fault-tolerant through redundancy and distribution of data. Cloud storage may be provided by a cloud service such as OneDrive, iCloud, Google Drive, Dropbox and Box. Each of the data storage sites may include a server and a storage device. The storage device may be any suitable devices including hard disks, optical disks, etc.

In a pre-storage processing, the 8-to-8 K muxing device 160 may convert 5 sets of input data S1, S2, S3, S4 and S5, to 8 sets of output data, i.e. D1, D2, D3, D4, D5, D6, D7 and D8, where:

D1=S1+S2+S3+S4+S5 (1-1)

D2=S1−S2+S3−S4+S5 (1-2)

D3=S1+S2−S3−S4+S5 (1-3)

D4=S1−S2−S3+S4+S5 (1-4)

D5=S1+S2+S3+S4−S5 (1-5)

D6=S1−S2+S3−S4−S5 (1-6)

D7=S1+S2−S3−S4−S5 (1-7)

D8=S1−S2−S3+S4−S5 (1-8)

An 8-to-8 Hadamard matrix HM, in which all elements are “1” or “−1” was chosen for the 8-to-8 K-muxing. The 8-to-8 K-muxing may be implemented by other orthogonal matrix such as Fourier transform or any 8×8 full rank matrices with realizable inverse matrices.

The input ports of the K-muxing device 160 are referred to as slices, and its output ports are wavefront components (wfc's). In this example, the five input data sets, S1, S2, S3, S4 and S5 are connected to the input ports, i.e., slice 1, slice 2, slice 3, slice 4 and slice 5, of the K-muxing device 160, respectively. The 8 output data sets D1-D8 are connected to the output ports wfc1 to wfc8, of the K-muxing device 160, respectively.

To create effective redundancy for data storage on cloud, two of the three grounding inputs, say the inputs of the 6^{th} and the 7^{th} slices, may be assigned as weighted sums of “all other 6 inputs” for the Hadamard Matrices and many orthogonal matrices instead of a constant. In this case, the last input slice for the 8-to-8 is grounded or assigned a constant value of zero.

D1=S1+S2+S3+S4+S5+f1+f2+0 (2-1)

D2=S1−S2+S3−S4+S5−f1+f2−0 (2-2)

D3=S1+S2−S3−S4+S5+f1−f2−0 (2-3)

D4=S1−S2−S3+S4+S5−f1−f2+0 (2-4)

D5=S1+S2+S3+S4−S5−f1−f2−0 (2-5)

D6=S1−S2+S3−S4−S5+f1−f2+0 (2-6)

D7=S1+S2−S3−S4−S5−f1+f2+0 (2-7)

D8=S1−S2−S3+S4−S5+f1+f2−0 (2-8)

where f1=S1+2*S2+S3+S4+S5+0 (3)

f2=S1+S2+2*S3+S4−S5+0 (4)

Equations (2-1) to (2-8) may be written in matrix form as

$$\begin{matrix}D = HM * S & ( 5 ) \\ where \text{:} D = {[ D 1 , D 2 , D 3 , D 4 , D 5 , D 6 , D 7 , D 8 ]}^{T} & ( 6 ) \\ HM = [ \begin{matrix}1 & 1 & 1 & 1 & 1 & 1 & 1 & 1 \\ 1 & - 1 & 1 & - 1 & 1 & - 1 & 1 & - 1 \\ 1 & 1 & - 1 & - 1 & 1 & 1 & - 1 & - 1 \\ 1 & - 1 & - 1 & 1 & 1 & - 1 & - 1 & 1 \\ 1 & 1 & 1 & 1 & - 1 & - 1 & - 1 & - 1 \\ 1 & - 1 & 1 & - 1 & - 1 & 1 & - 1 & 1 \\ 1 & 1 & - 1 & - 1 & - 1 & - 1 & 1 & 1 \\ 1 & - 1 & - 1 & 1 & - 1 & 1 & 1 & - 1\end{matrix} ] & ( 7 ) \\ S = {[ S 1 , S 2 , S 3 , S 4 , S 5 , f 1 , f 2 , 0 ]}^{T} & ( 8 )\end{matrix}$$

When the K muxing is connected by a unity input data set only, e.g. S4=[1] through the input port of slice 4 and S1=S2=S3=S5=f1=f2=0, the corresponding outputs of the WF muxing device 160 are written as:

D1=S1+S2+S3+S4+S5+f1+f2+0=[1] (9-1)

D2=S1−S2+S3−S4+S5−f1+f2−0=[−1] (9-2)

D3=S1+S2−S3−S4+S5+f1−f2−0=[−1] (9-3)

D4=S1−S2−S3+S4+S5−f1−f2+0=[1] (9-4)

D5=S1+S2+S3+S4−S5−f1−f2−0=[1] (9-5)

D6=S1−S2+S3−S4−S5+f1−f2+0=[−1] (9-6)

D7=S1+S2−S3−S4−S5−f1+f2+0=[−1] (9-7)

D8=S1−S2−S3+S4−S5+f1+f2−0=[1] (9-8)

The 8 output data sets are represented as a column vector or an output column matrix. The elements of the output matrix D, under the condition, become identical to the 8 elements in the 4^{th} column of the HM. In this case, the wavefront vector of the output data sets representing the matrix D is referred to as the 4^{th}wavefront vector (WFV), or WFV4. Similarly, the wavefront vector associated with the k^{th} input port, Slice k, is referred to as k^{th} WFV or WFVk. A WF vector specifies the distribution of a set of input data among the 8-output ports or among 8 aggregated output data sets D1, D2, D3, D4, D5, D6, D7 and D8.

In general, an 8-to-8 WF muxer, such as the K-muxing device 160, features 8 orthogonal WFV's. Let us define a coefficient wjk of a Wavefront (WF) transform, or a K-transform performed by the K-muxing device 160 to be the coefficient at the j^{th} row and k^{th} column of the K-muxing device 160. A WF vector of the K-muxing device 160 featuring a distribution among the 8 outputs D1-D8 at the 8 wavefront component (wfc) ports wfc1-wfc8, is defined as an 8-dimensional vector.

With 8 wfc ports in the 8-to-8 K-muxing 130, there will be 8 mutually orthogonal WFVs. The first 5 WFVs are:

WFV1=[w11, w21, w31, w41, w51, w61, w71, w81]^{T} (10-1)

WFV2=[w12, w22, w32, w42, w52, w62, w72, w82]^{T} (10-2)

WFV3=[w13, w23, w33, w43, w53, w63, w73, w83]^{T} (10-3)

WFV4=[w14, w24, w34, w44, w54, w64, w74, w84]^{T} (10-4)

WFV5=[w15, w25, w35, w45, w55, w65, w75, w85]^{T} (10-5)

S1, S2, S3, S4, and S5 are “attached” to 5 WF vectors by respectively connected to the first five input ports of the K-muxing device 160. Similarly, f1 and f2 are attached to the WFV6 and the WFV7. As a result, there is a remaining WFV, i.e., WFV8, which is not “utilized” in this illustration. All components of the 8 orthogonal WFVs are related to input and output port numbers or (spatial) sequences, but are independent from the input and output data sets.

Each of the 8 outputs D1-D8 of the K-muxing function 160 is a linear combination of the 8 inputs including S1-S5, f1 and f2. The linear combination with 8 inputs features a weighted sum with each input weighted by a corresponding weighting parameter. As a result, each of the 8 outputs D1-D8 contains information associated with all of the 8 inputs including S1-S5, f1 and f2. The data storage sites 171 through 178 may store all the 8 output data sets D1-D8, respectively.

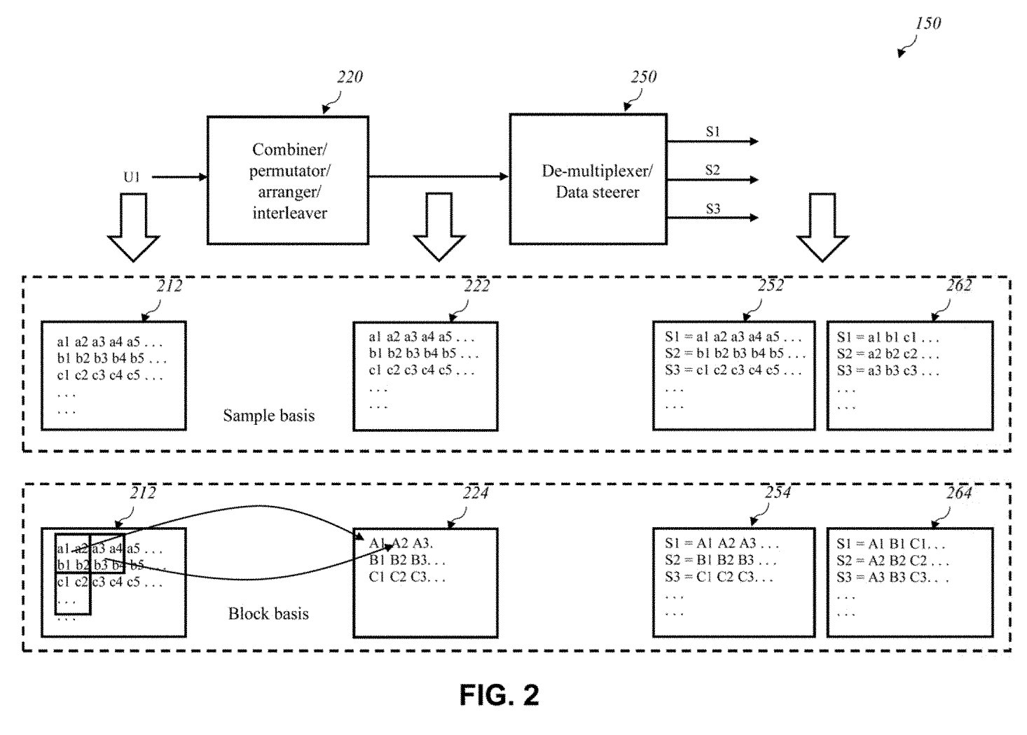

FIG. 2 is a diagram illustrating the segmenter 150 shown in FIG. 1 according to one embodiment. The segmenter 150 includes a data arranger 220 and a data steerer 250. The segmenter 150 may include more or less than the above components. The segmenter 150 may operate on a sample basis or a block basis. A basis refers to the data size of the operational unit of the media input. For example, if the media input is an image or an image sequence, the operational unit may be a pixel or a block of pixels. The pixel basis may be referred to as a sample basis and the block of pixels basis may be referred to as a block basis. The data size of the pixel may be a 24-bit data. The data size of the block may be K×L pixels where K and L may be any convenient integers, e.g. 2, 3, 4.

The data arranger 220 operates on an input 212 to generate a sample arranged output 222 or a block arranged output 224. It may leave the input unchanged or re-arrange the input data using certain data formatting pattern. The pattern may be provided by a pre-defined structure or function such as permutation, interleaving. A permutation is a rearrangement of the elements of an ordered list L into a one-to-one correspondence with the ordered list L itself. An interleaving mixes or merges multiple lists in a certain order, for example in alternating order. The input 212 may be represented by a set of lists of pixels. The data steerer 250 steers the arranged output 222/224 into multiple data segments; for example, segments S1, S2, and S3.

FIG. 2 illustrates an example for an image input and a sample basis and a block basis. For the sample basis, the image input 212 is processed by the data arranger 220 to generate the sample arranged output 222. In the example, the data arranger 220 leaves the input unchanged. The output of the data steerer 250 is a set of data 252 or 262. In the data set 252, the segments S1, S2, and S3 correspond to the rows of the sample arranged output 222, such that S1=a1 a2 a3 . . . d1 d2 d3 . . S2=b1 b2 b3 . . . e1 e2 e3, S3=c1 c2 c3 . . . f1 f2 f3 . . . In the data set 262, the segments S1, S2, and S3 correspond to the columns of the arranged output 222: S1=a1 b1 c1 . . . , S2=a2 b2 c2 . . . , S3=a3 b3 c3

For the block basis, similar operations as in the sample basis may be performed except that the operations are performed on a block basis where each block corresponds to a block of pixels. For example, the data arranger 220 arranges the image input 212 into a block arranged output 224. The block arranged output 224 may include rows of blocks A1 A2 A3 . . . B1 B2 B3 . . . where each block represents a block of pixels. The block of pixels may be represented by any known representation. For example, the block may be linearized rowwise. In this scheme, A1 may be represented by a1 a2 b1 b2. The output of the data steerer 250 is a set of data 254 or 264. In the data set 254, the segments S1, S2, and S3 correspond to the rows of the sample arranged output 222, such that S1=A1 A2 A3 . . . D1 D2 D3 . S2=B1 B2 B3 . . . E1 E2 E3, S3=C1 C2 C3 . . . F1 F2 F3 . . . In the data set 262, the segments S1, S2, and S3 correspond to the columns of the arranged output 222: S1=A1 B1 C1 . . . , S2=A2 B2 C2 . . . , S3=A3 B3 C3 . . .

The operations of the data arranger 220 and the data steerer 250 are based on the following criteria: (1) the data arrangement and steering are performed using procedures known by a user at the receiving side who will recover the media input after retrieving the data stored on the network storages; and (2) the data arrangement and steering are performed to convert a single media input or a plurality of media inputs into a suitable number of outputs based on the architecture of the K muxing device 160. In the example in FIG. 1, the single media input 130 is converted into 3 outputs 51, S2, and S3.

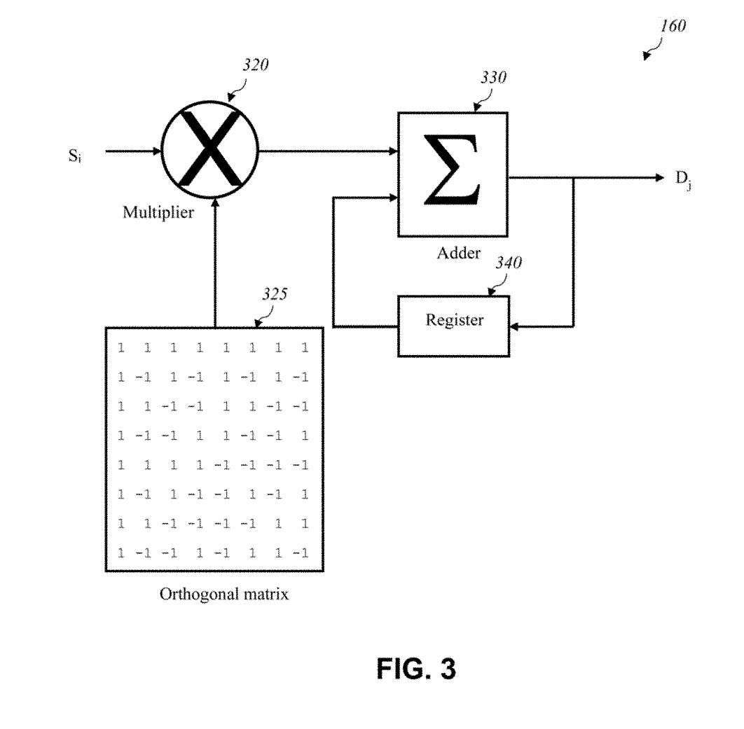

FIG. 3 is a diagram illustrating a WFM device 160 shown in FIG. 1 according to one embodiment. The WFM device 160 includes a multiplier 320, a memory 325, an adder 330, and a register 340. The WFM device 160 may contain more or less than the above components. In addition, the WFM device 160 may be implemented by hardware circuits as shown in FIG. 3, or by instructions executed by a processor.

The multiplier 320 multiplies the Si data from the segmenter 150 with the matrix coefficients stored in the memory 325. The matrix coefficients are the HM coefficients in equation (7). As is known by one skilled in the art, other types of matrix coefficients may be used, as long as they are orthogonal. The adder 330 adds the resulting product with the partial sum previously computed to produce the output Dⱼ. The register 340 stores the partial sum as the partial sum is accumulated to add the individual product terms from the multiplier 320. Initially, the register 340 is cleared to zero. It is reset or cleared to zero again at the beginning of each row. In the example shown in FIGS. 2 and 3, S1=S1, S2, S3, S4, S5 and Dⱼ=D1 through D8. The calculation of Dⱼ (j=1, . . . , 8) is performed according to equations (9-1) to (9-8).

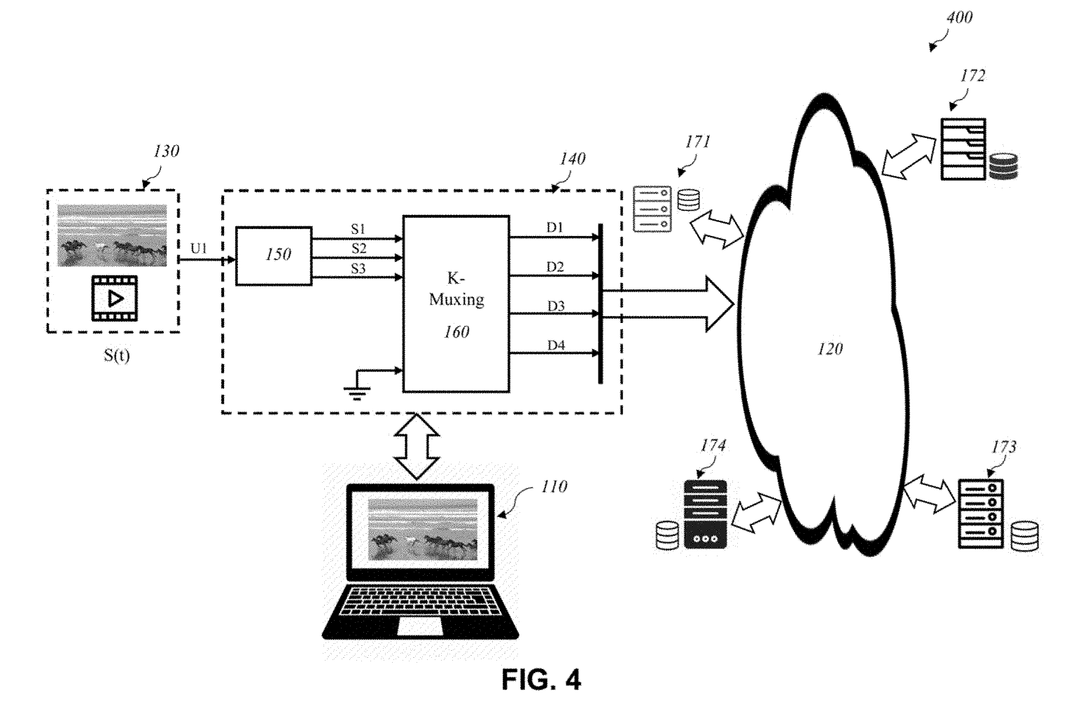

FIG. 4 is a diagram illustrating system 400 using a 4-to-4 preprocessor according to one embodiment. The system 400 is similar to the system 100 in FIG. 1 except that it uses a 4-to-4 preprocessor instead of an 8-to-8 preprocessor. The system 400 includes the computing device 110 having the pre-processing functionality 140, the media input 130, the network 120, and a set of servers and storages 171, 172, 173, and 174. For brevity, components having the same reference labels as in FIG. 1 are not described again.

FIG. 4 depicts a writing process to store 3 sets of data, 51, S2, and S3, in 4 physically separated network storage sites 171, 172, 173, and 174 connected through the network 120. The writing process features techniques of wavefront multiplexing (WF muxing or a K-muxing 160). The 4-to-4 K-muxing device 160 features 4 inputs and 4 outputs. One of the 4 inputs is grounded or not used. It may also be connected to a known constant or a known data stream. Furthermore, the first three data sets, S1, S2 and S3, are results of segmenting a data set S(t) by the segmenter 150. In this example, the media input 130 is a short video clip on wild life.

In a pre-storage processing, the 4-to-4 K muxing device 160 is used to convert 3 sets of input data S1, S2, and S3 to 4 sets of output data D1, D2, D3, and D4, where:

D1=S1+S2+S3 (11-1)

D2=S1−S2+S3 (11-2)

D3=S1+S2−S3 (11-3)

D4=S1−S2−S3 (11-4)

Suppose D1, D2, D3, and D4 are known and S1, S2, S3 are unknown. As seen from the above equations (11-1) to (11-4), there are 4 equations having 3 unknowns. Therefore, one equation is extraneous or redundant. Any equation may be considered as redundant so that only the other three equations may be used to solve for the three unknowns. Regardless of what equation is used as the redundant equation, the solutions for the other three equations always give the same results for the three unknowns.

As a numerical example to illustrate this redundancy feature, suppose the three unknowns S1, S2, and S3 have the values 1, 2, and −1, respectively. The equations (11-1) to (11-3) will give the 4 values for D1, D2, D3, and D4 as 2, −2, 4, and 0, respectively.

Suppose equation (11-3) is considered redundant. Solving the three equations (11-1), (11-2), and (11-4) will give the solutions for S1, S2, and S3 as follows:

$$\begin{matrix}( \begin{matrix}D 1 \\ D 2 \\ D 4\end{matrix} ) = ( \begin{matrix}1 & 1 & 1 \\ 1 & - 1 & 1 \\ 1 & - 1 & - 1\end{matrix} ) ( \begin{matrix}S 1 \\ S 2 \\ S 3\end{matrix} ) & ( E \text{-} 1 ) \\ ( \begin{matrix}S 1 \\ S 2 \\ S 3\end{matrix} ) = {( \begin{matrix}1 & 1 & 1 \\ 1 & - 1 & 1 \\ 1 & - 1 & - 1\end{matrix} )}^{- 1} ( \begin{matrix}D 1 \\ D 2 \\ D 4\end{matrix} ) & ( E \text{-} 2 ) \\ ( \begin{matrix}S 1 \\ S 2 \\ S 3\end{matrix} ) = 1 / 2 ( \begin{matrix}1 & 0 & 1 \\ 1 & - 1 & 0 \\ 0 & 1 & - 1\end{matrix} ) ( \begin{matrix}2 \\ - 2 \\ 0\end{matrix} ) = ( \begin{matrix}1 \\ 2 \\ - 1\end{matrix} ) & ( E \text{-} 3 )\end{matrix}$$

Now, suppose equation (11-4) is redundant. Solving the three equations (11-1), (11-2), and (11-3) will give the solutions for S1, S2, and S3 as follows:

$$\begin{matrix}( \begin{matrix}D 1 \\ D 2 \\ D 3\end{matrix} ) = ( \begin{matrix}1 & 1 & 1 \\ 1 & - 1 & 1 \\ 1 & 1 & - 1\end{matrix} ) ( \begin{matrix}S 1 \\ S 2 \\ S 3\end{matrix} ) & ( E \text{-} 4 ) \\ ( \begin{matrix}S 1 \\ S 2 \\ S 3\end{matrix} ) = {( \begin{matrix}1 & 1 & 1 \\ 1 & - 1 & 1 \\ 1 & 1 & - 1\end{matrix} )}^{- 1} ( \begin{matrix}D 1 \\ D 2 \\ D 3\end{matrix} ) & ( E \text{-} 5 ) \\ ( \begin{matrix}S 1 \\ S 2 \\ S 3\end{matrix} ) = 1 / 2 ( \begin{matrix}0 & 1 & 1 \\ 1 & - 1 & 0 \\ 1 & 0 & - 1\end{matrix} ) ( \begin{matrix}2 \\ - 2 \\ 4\end{matrix} ) = ( \begin{matrix}1 \\ 2 \\ - 1\end{matrix} ) & ( E \text{-} 6 )\end{matrix}$$

In general, a K-muxing function having M inputs and N outputs where N≥M will have N-M redundant outputs. The redundant outputs may be used for data integrity, diagnostic, or any other security purposes.

A 4-to-4 Hadamard matrix HM, in which all elements are “1” or “−1” is chosen for the 4-to-4 K-muxing. As with the 8-to-8 K-muxing, the 4-to-4 K-muxing may be implemented by other orthogonal matrices such as Fourier transfer or any 4×4 full rank matrixes with realizable inverse matrices. Equations (11-1) to (11-4) may be written in a matrix form as

$$\begin{matrix}D = HM * S & ( 12 ) \\ where \text{:} D = {[ D 1 , D 2 , D 3 , D 4 ]}^{T} & ( 13 ) \\ HM = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] & ( 14 ) \\ S = {[ S 1 , S 2 , S 3 , 0 ]}^{T} & ( 15 )\end{matrix}$$

Similarly to FIG. 1, the wavefront vector associated with the k^{th} input port, Slice k, is referred to as k^{th} WFV or WFVk. A WF vector specifies the distribution of a set of input data among the 4-output ports or among 4 aggregated output data sets D1, D2, D3 and D4.

In general, a 4-to-4 WF muxer, such as the K muxing device 160, features 4 orthogonal WFV's. Define a coefficient wⱼₖ of a Wavefront (WF) transform, or a K-transform performed by the 4-to-4 K-muxing device 160 to be the coefficient at the i^{th} row and k^{th} column of the K-muxing device 160. A WF vector of the 4-to-4 K-muxing 160 featuring a distribution among the 4 outputs D1, D2, D3, and D4 at the 4 wavefront component (wfc) ports wfc1-wfc4, is defined as a 4-dimensional vector.

With 4 wfc ports in the 4-to-4 K-muxing 160, there shall be 4 mutually orthogonal WFVs. The first 3 WFVs are:

WFV1=[w11, w21, w31, w41]^{T} (16-1)

WFV2=[w12, w22, w32, w42]^{T} (16-2)

WFV3=[w13, w23, w33, w43]^{T} (16-3)

S1, S2, and S3 are “attached” to the 3 WF vectors by respectively connected to the first three input ports of the K-muxing device 160. As a result, there is one remaining WFV, i.e. WFV4, which is not “utilized” in this illustration. All components of the 4 orthogonal WFVs are related to input and output port numbers or (spatial) sequences, but are independent from the input and output data sets.

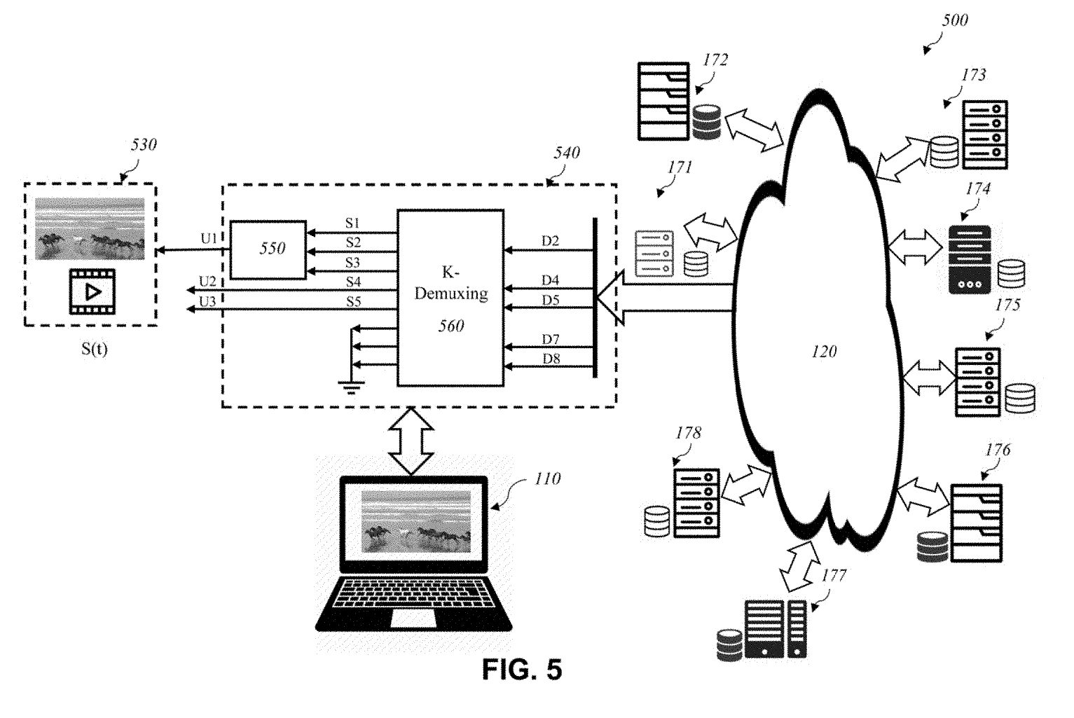

FIG. 5 is a diagram illustrating a system 500 with an 8-to-8 postprocessor at a receiver side and network servers according to one embodiment. The system 500 includes the computing device 110, the network 120, the eight servers and network storages 171 to 178, a K-demuxing functionality 540, and a media output 530. The system 500 may include more or less than the above components. The computing device 110, the network 120, the eight servers and network storages 171 to 178 are similar to those shown in FIG. 1 with the same reference numerals and therefore do not need further description.

FIG. 5 depicts a corresponding reading process to the writing process in FIG. 1. The WF de-multiplexing is performed via an 8-to-8 K-de-muxing functionality 540. It may be used to recover 5 sets of data S1, S2, S3, S4 and S5 from any subset of five data sets of the eight physically separated data storage sites or servers and network storages 172 through 178 connected through the network 120. In this example, the select subset includes D2, D4, D5, D7 and D8.

After the 8-to-8 K-de-muxing 540, the first three data sets S1, S2, and S3 are de-segmented or combined into a large data set media output S(t) 530 by a de-segmentation processor or de-segmenter 550. The recovered data set media output S(t) 530 are substantially equivalent to the data set media input S(t) 130 in FIG. 1.

FIG. 5 shows the retrieval processing of the 5 recovered data S1-S5 substantially equivalent to the input data sets S1-S5 respectively in FIG.1, only when 5 stored data sets D2, D4, D5, D7 and D8, which are substantially equivalent to the data sets D2, D4, D5, D7 and D8 respectively in FIG. 1, are accessible from five of the eight storage sites or servers and network storages 171 through 178. Each of the outputs of the 8-to-8 K-de-muxing 560 or retrieved data sets S1-55 is a linear combination of the 5 inputs D2, D4, D5, D7 and D8. The linear combination is a weighted sum of all 5 inputs; each weighted by a corresponding weighting parameter before a summing operation. Thus, each of the outputs or retrieved data sets S1-S5, contains information associated with all of the 5 inputs D2, D4, D5, D7 and D8. The retrieval process further includes the grouping of the first 3 retrieved data sets S1, S2, and S3 into a large data set S(t) via a de-segmentation processor or de-segmenter 550. The retrieved data sets S4 and S5 are substantially equivalent to the input data sets S4 and S5 respectively in FIG. 1.

When all 8 storage data sets become available, the 8-to-8 K-demuxing 560 may be efficiently implemented as a matrix inversion of the corresponding matrix for the 8-to-8 K-muxing 160 in FIG. 1. When K-muxing 160 implemented by a Hadamard matrix, the identical matrix can be used for efficient implementations for the K-de-muxing 560.

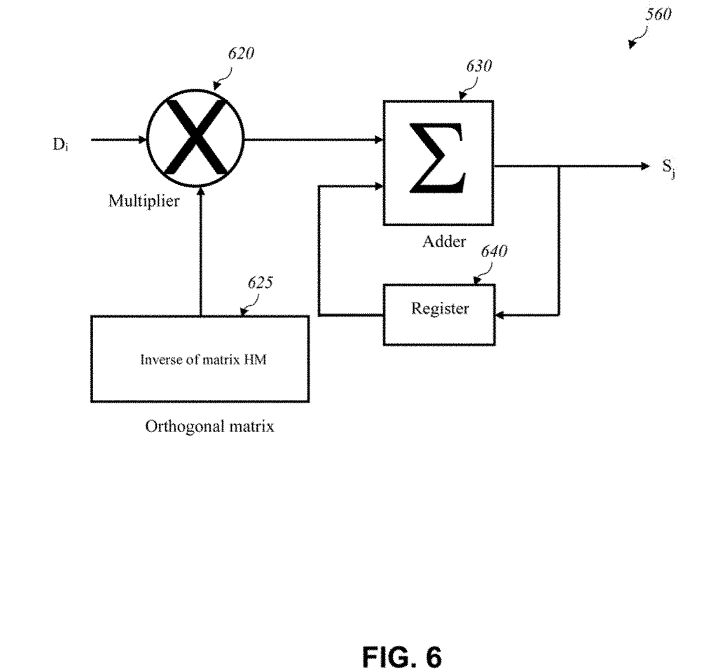

FIG. 6 is a diagram illustrating a WFD functionality 560 according to one embodiment. The WFD functionality 560 includes a multiplier 620, a coefficient memory 625, an adder 630, and a register 640. It is similar to the WFM functionality 160 shown in FIG. 3 except that the coefficient memory 625 contains the coefficients of the inverse matrix HM. Like the WFM 160 in FIG. 3, the WFD device 560 may be implemented by hardware circuits as shown in FIG. 6, or by instructions executed by a processor.

The multiplier 620 multiplies the D1 data retrieved from the network storages 171 through 178 with the matrix coefficients stored in the memory 625. The matrix coefficients are the inverse HM coefficients in equation (7). As is known by one skilled in the art, other types of matrix coefficients may be used, as long as they are orthogonal. The adder 630 adds the resulting product with the partial sum previously computed to produce the output Sⱼ. The register 640 stores the partial sum as the partial sum is accumulated to add the individual product terms from the multiplier 620. Initially, the register 640 is cleared to zero. It is reset or cleared to zero again at the beginning of each row. In the example shown in FIGS. 5 and 6, D1=D2, D4, D5, D7, and D8, and Sⱼ=S1 through S5. The other three outputs of the K-de-muxing 560 are not used and may be grounded.

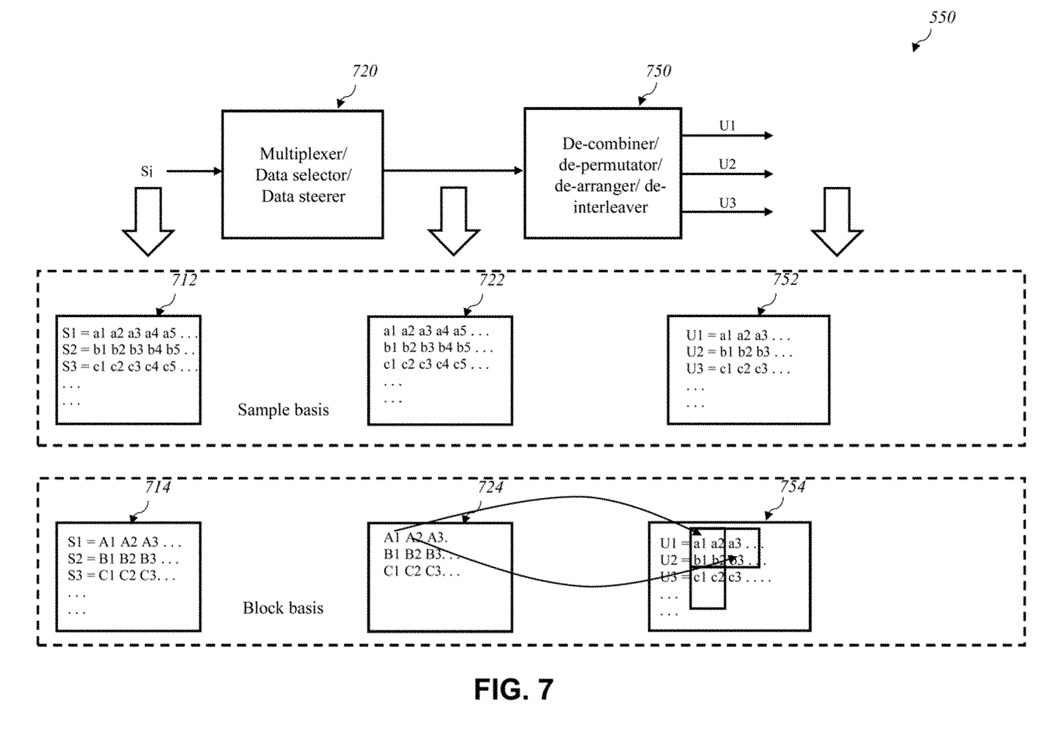

FIG. 7 is a diagram illustrating the de-segmenter 550 shown in FIG. 5 according to one embodiment. The de-segmenter 550 includes a data steerer 720 and a de-arranger 750. The de-segmenter 550 may be implemented by hardware circuits or by instructions executed by the processor. The de-segmenter 550 operates the reverse of the segmenter 150 in FIG. 2 to re-assemble the data after the K-demuxing 560.

The de-segmenter 550 may operate on a sample basis or a block basis according to the basis used by the pre-processing shown in FIG. 1. On a sample basis, the data steerer 720 receives the data 712 in sample format and steer the data in reverse order of the format done by the data steerer 250 shown in FIG. 2 to produce the data 722. The de-arranger 750 then re-arranges the data 722 in the reverse order of the arrangement by the data arranger 220 shown in FIG. 2. For example, if the data arranger 220 uses interleaving, the de-arranger 750 will use de-interleaving to split the data. In a similar manner, if the basis is a block basis, the data steerer 720 and the data de-arranger 750 re-assembles the data on a block-by-block basis from the data 714 to 724 and finally to 754 as shown in FIG. 7.

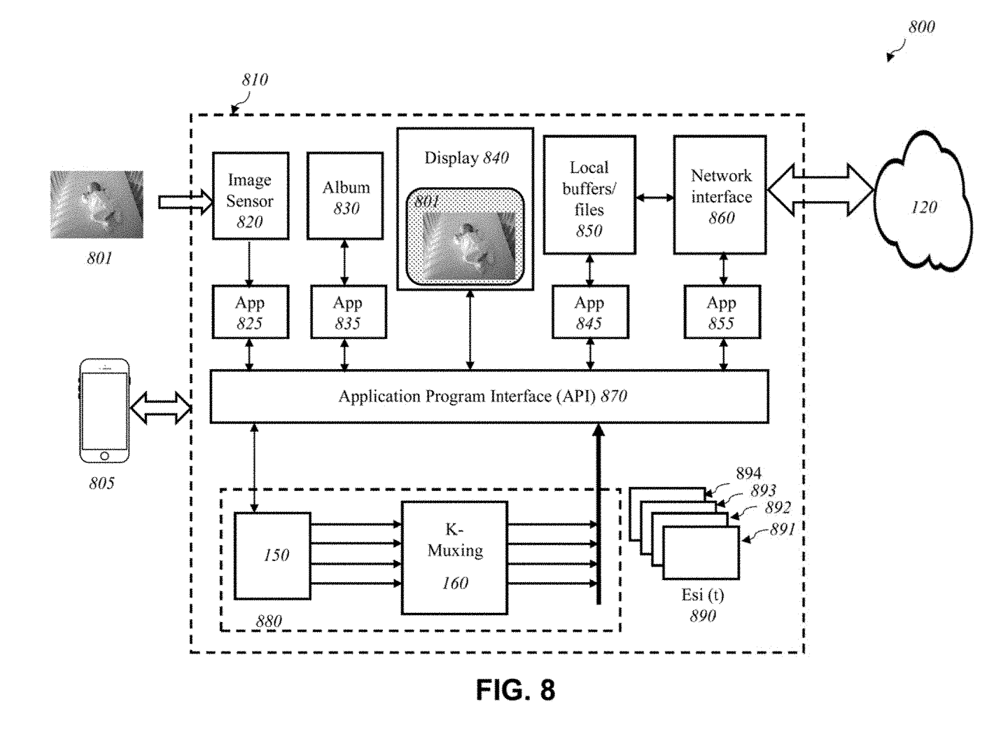

FIG. 8 is a diagram illustrating a system 800 with a mobile device using WF muxing according to one embodiment. The system 800 includes a mobile device 805, a media input 801, and the network 120. The mobile device 805 is equipped with a functionality 810. The functionality 810 performs pre-processing without redundancy in a mobile environment.

The functionality 810 depicts a functional structure in the mobile device 805 of K-muxing a data file for storage over distributed network storages such as cloud storage without redundancy. The mobile device 805 may be a smart phone, or any other mobile device having some computational and communication capability. The functionality 810 includes an image sensor 820, an album 830, a display 840, a set of local buffers and files 850, a network interface 860, a pre-processing functionality 880, and a set 890 of files.

The image sensor 820 senses or captures real-time images or video as the media input 801 under the control of a sensor application 825. The captured image or video clip is stored in the local album 830 under the control of an album application 835. The display 840 displays the captured image or video clip as the media input 801. The local buffers or files 850 store individual files corresponding to various applications such as local file synchronization management of cloud storage such as Dropbox, Google drive, iCloud, OneDrive, and others. The network interface 860 provides network connectivity and other interfacing functions to the network 120 under the control of a network application 855. The network interface 860 provides wired or wireless connectivity to the network 120. Any other interfaces may be used including universal serial bus (USB) to local storages. The local buffers or files 850 may also interface directly to the network interface 860 to send the image, video clip, or files to the network 120.

An application program interface (API) 870 provides overall interface to all the individual applications 825, 835, 845, 855, and the display 840. The API 870 also provides interface to the pre-processing functionality 880. The API 870 may include a set of routines, protocols, and tools for building software applications. It may specify how software components should interact and provide graphical user interface (GUI) components. The API 870 makes it easier to develop a program by providing all the building blocks which may be used to tailor to a particular application.

The pre-processing functionality 880 is similar to the functionality 140 in FIG. 1 except that it has interface to the API 870 to receive the inputs and transmit the outputs. It has the segmenter 150 and the K-muxing 160. In this example, the K-muxing 160 is a 4-to-4 processor. As is known by one skilled in the art, other numbers of inputs and outputs may be used. The pre-processing functionality 880 generates 4 outputs Esi(t) 890 which includes 4 outputs 891, 892, 893, and 894.

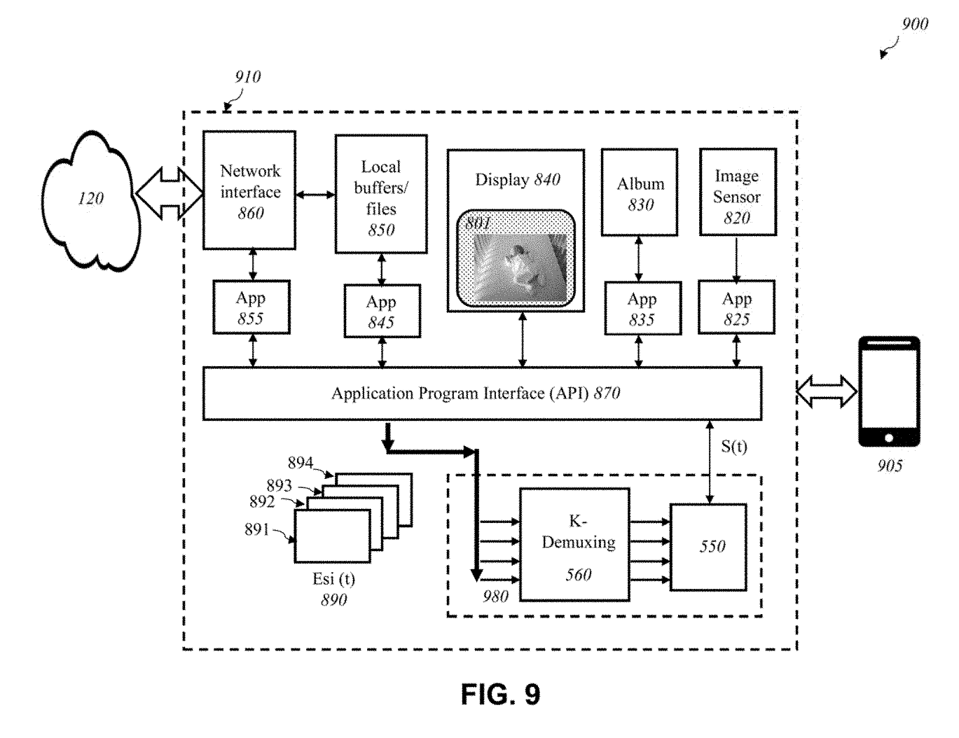

FIG. 9 is a diagram illustrating a system 900 with a mobile device using WF de-muxing according to one embodiment. The system 900 includes a network 120 and a mobile device 905. The mobile device 905 is equipped with a functionality 910. The functionality 910 performs post-processing without redundancy in a mobile environment.

The functionality 910 includes a functional structure in a mobile device for recovering stored pictures or video clips by K-demuxing a set of muxed media files stored, without redundancy, over network storages such as distributed cloud storage. The functionality 910 is similar to the functionality 810 in FIG. 8 except that it has a post-processing functionality 980 instead of the pre-processing 880. The functionality 910 includes the same components as in the functionality 810 except that the processing chain is the reverse in that the media files, such as the set Esi(t) 890 having four files 891 to 894, are retrieved from the network storages via the network 120 and sent through the network interface 860, stored in the local buffers/files 850, processed by the post-processing functionality 980, stored in the album 830, and displayed as the media file 801 on the display 840 via the API 870 and the individual applications 855, 845, and 835. The image sensor 820 and the sensor application 825 are normally not used in this reverse processing chain.

The post-processing functionality 980 is similar to the post-processing functionality 540 in FIG. 5. It includes the K-demuxing 560 and the de-segmenter 550. Since these components are described earlier, they are not described here further.

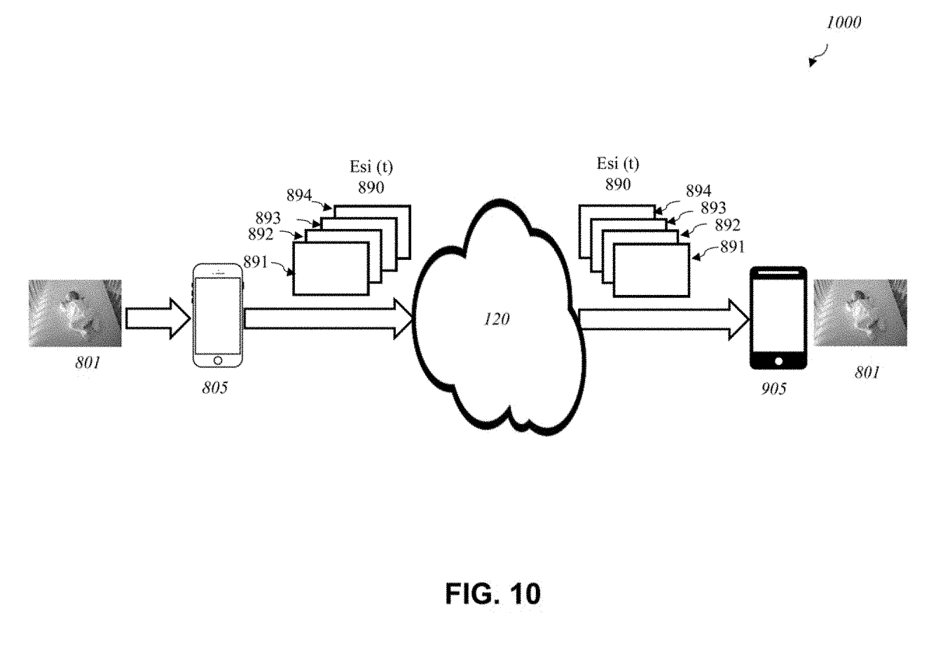

FIG. 10 is a diagram illustrating a system 1000 using mobile devices with WF muxing and de-muxing according to one embodiment. The system 1000 includes the media input 801, the mobile device 805, the set Esi(t) 890 having four files 891 to 894, the network 120, the retrieved four files Esi(t), and the mobile device 905.

In essence, the system 1000 is the combination of the system 800 and the system 900. Since it uses the same components as in the systems 800 and 900, the description of the system 1000 is not repeated here. It should also be noted that the mobile devices 805 and 905 may be different devices or the same device.

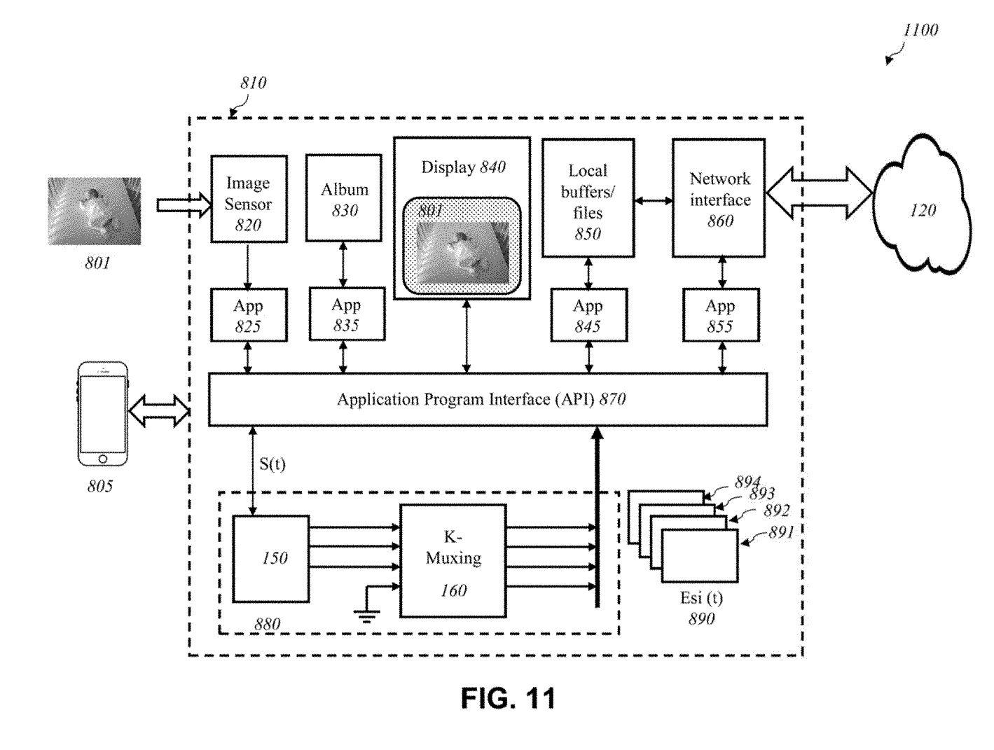

FIG. 11 is a diagram illustrating a system 1100 using a mobile device with WF muxing and 3-for-4 redundancy according to one embodiment. The system 1100 is similar to the system 800 in FIG. 8 except that the pre-processing functionality 880 is a 3-for-4 redundancy pre-processing with similar functionality as the pre-processing functionality 140 shown in FIG. 4. Since the components in the system 1100 are the same as the components with the same reference numerals, their specific description will not be repeated here.

The pre-processing functionality 880 includes the segmenting function 150 and the K-muxing 160 which are similar to the same components in FIG. 1. The main difference is the 3-for-4 redundancy introduced. The 3-for-4 redundancy operates on the principle discussed above in relation to equations (11-1) to (11-4). The actual number of inputs to the K-muxing function 160 representing the media input is less than the actual number of outputs from the K-muxing function 160. The extra output or outputs are redundant and may be used for other purposes such as data integrity or diagnostic. For example, in the 3-for-4 redundancy, the number of inputs is 3 and the number of outputs is 4.

The segmenting function 150 and the K-muxing function 160 are similar to the same components in FIG. 4 and therefore will not be described further. The 1-to-3 data steerer 150 converts the data stream S(t) with a 3R samples per second into three data sub-streams, each with a flowing rate of a R samples per second. These three data substrings are then connected to 3 of the 4 inputs of the K-muxing 160 implemented by a 4-to-4 Hadamard matrix. The remaining 4^{th} input is grounded as shown, connected to a known constant, or fed by a known digital file. Its four outputs Esi (or Es1, Es2, Es3, and Es4) are then uploaded to the network 120 through local buffers 850 as discussed before.

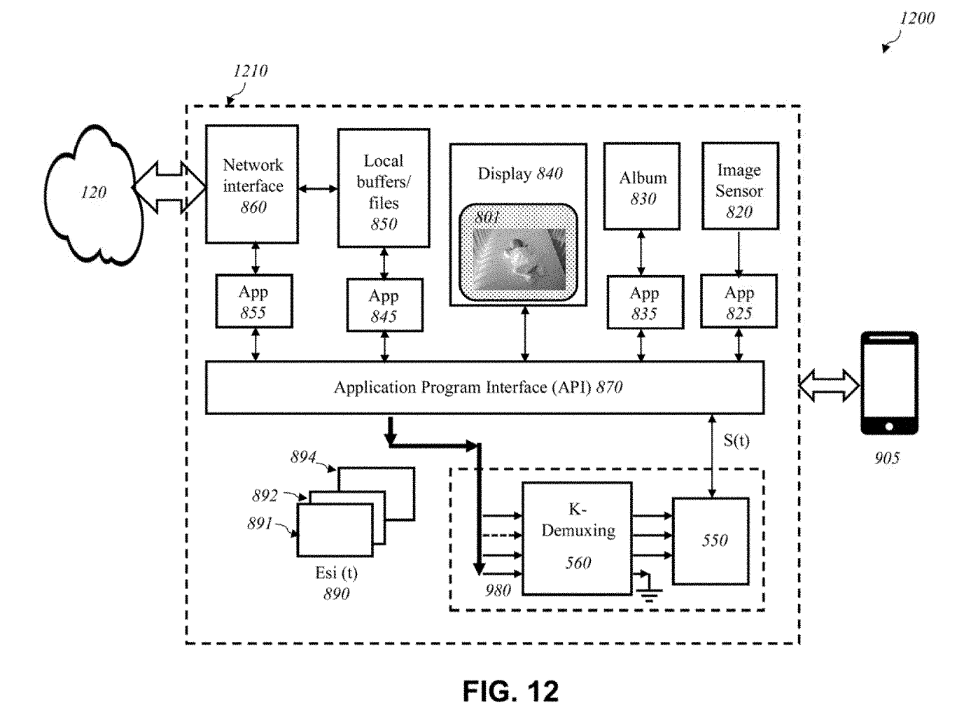

FIG. 12 is a diagram illustrating a system 1200 using a mobile device with WF de-muxing and 3-for-4 redundancy according to one embodiment. The system 1200 is similar to the system 900 in FIG. 9 except that the post-processing functionality 980 is a 3-for-4 redundancy post-processing with similar functionality as the post-processing functionality 540 shown in FIG. 5 with the exception that only 3 of the 4 data files are needed in the K-de-muxing 560. Any three files from the four files retrieved from the network storages connected to the network 120 may be used. The unused file is a redundant file and may be used for data integrity check or diagnostic. Since the components in the system 1200 are the same as the components with the same reference numerals, their description will not be repeated here.

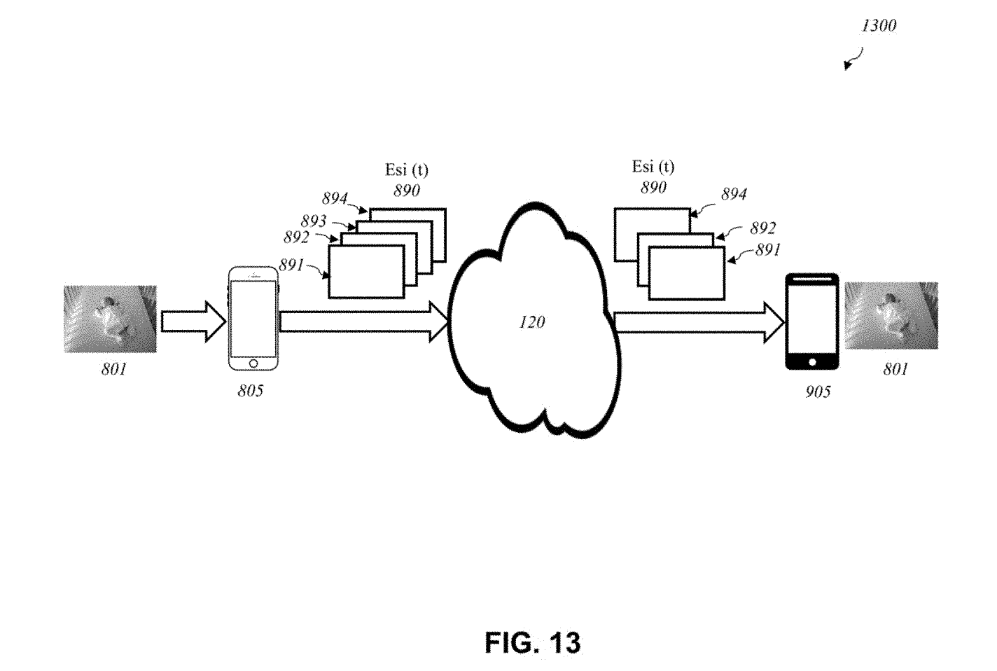

FIG. 13 is a diagram illustrating a system 1300 using mobile devices with WF muxing and de-muxing and 3-for-4 redundancy according to one embodiment. The system 1300 includes mobile devices 805 and 905 with network connectivity to the network 120.

The mobile device 805 in FIG. 13 is similar to the mobile device 805 shown in FIG. 11. It operates at the transmitter as a pre-processing functionality that obtains the media input 801 and generates the set Esi(t) 890 of 4 document files 891 894 representing the 3-to-4 redundant data files. The mobile device 905 in FIG. 13 is similar to the mobile device 905 shown in FIG. 12. It operates at the receiver side as a post-processing functionality that retrieves the set Esi(t) 890 having three document files 891, 892, and 894. The mobile device 905 recovers the media input 801 through the K-de-muxing functionality as described above.

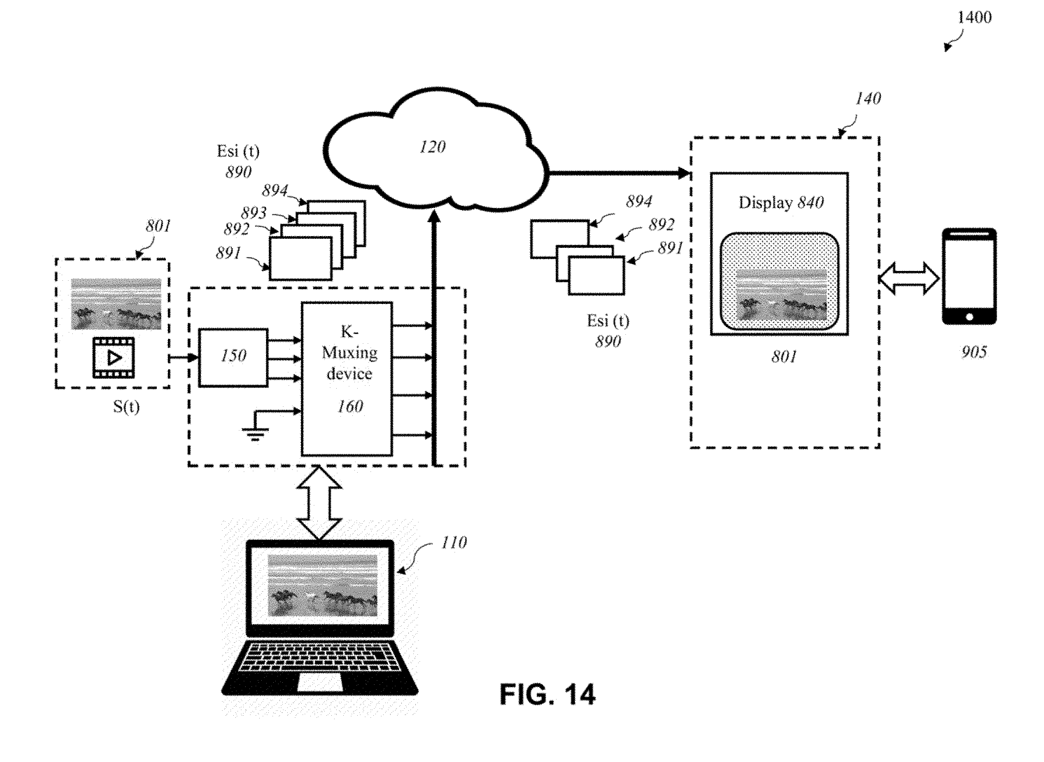

FIG. 14 is a diagram illustrating a system 1400 using mobile devices with WF muxing and de-muxing and 3-for-4 redundancy according to one embodiment. The system 1400 is similar to the system 1300 except that a fixed computing device 110 is used instead of the mobile device 805. The media input 801 may be a media file stored locally on the computing device 110 of captured in real-time by an image sensor as a part of the computing device 110 or sent to the computing device 110 via a network connectivity or communication interface (e.g., USB connection).

Furthermore, it is notice that there are 24 connectivity combinations between 4 input ports and 4 input signals. For any 4-to-4 K-muxing processor with same set of the 4 input signals, every one of the 24 combinations will result to a unique set of Esi; where i=1, 2, 3, and 4. Without the information in a K-demuxing operation, it will be difficult to reconstruct the original data set S(t) even we have retrieved from the network storages all 4 stored K-muxed data sets (Esi; where i=1, 2, 3, and 4). The connectivity and other configuration information as well as configuration combinations shall be one of the important items in a registry for configuration management. Other configurations may include between 4 outputs of a K-muxing and accessible multiple storages on cloud including those on private cloud and other private local storages connected by IP networks.

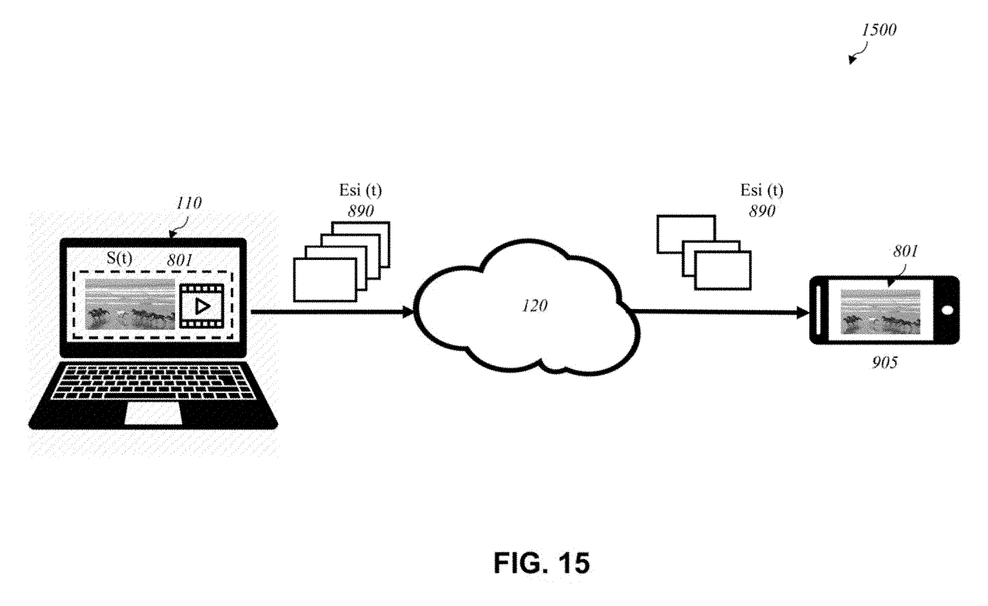

FIG. 15 is a diagram illustrating a simplified system 1500 using mobile devices with WF muxing and de-muxing and 3-for-4 redundancy according to one embodiment. The system 1500 is a simplified version of the system 1400 shown in FIG. 14. The computing device 110 performs K-muxing on the media file 801 with a 3-to-4 redundancy and sends the set Esi(t) 890 to the network 120. The mobile device 905 retrieves three document files of the set Esi(t) 890 from the network storage and recovers the original media file 801 and displays it on the screen display.

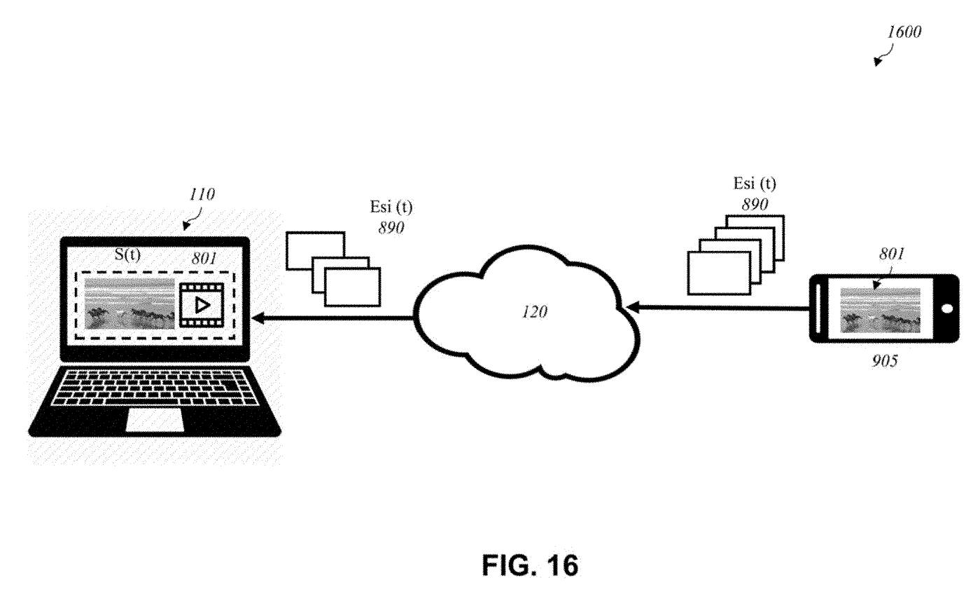

FIG. 16 is a diagram illustrating a system 1600 with a WFD device according to one embodiment. The system 1600 is similar to the system 1500 shown in FIG. 15 except that the roles of the computing device 110 and the mobile device 905 are reversed. In the system 1600, the mobile device 905 operates at the transmitter side and performs K-muxing on the media input 801. It sends the set Esi(t) 890 of 4 document files to the network storage connected to the network 120. The computing device 110 operates at the receiver side and performs K-de-muxing on the three document files from the set Esi(t) 890 retrieved from the network storages connected to the network 120.

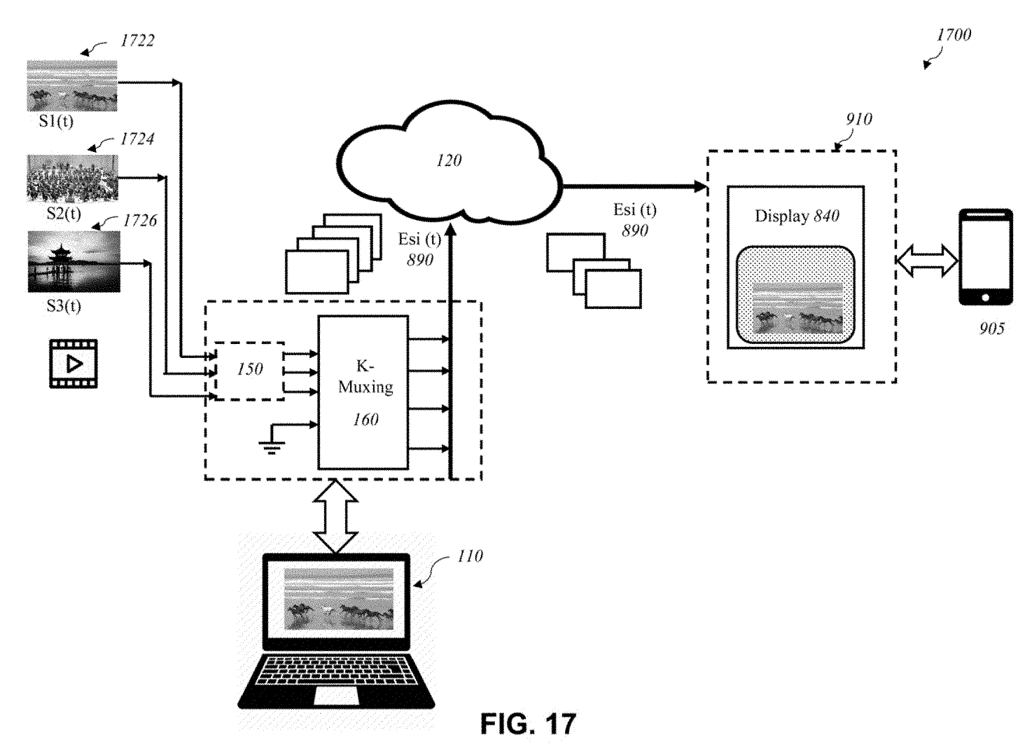

FIG. 17 is a diagram illustrating a system 1700 having multiple media inputs and using mobile devices with WF muxing and de-muxing and 3-for-4 redundancy according to one embodiment. The system 1700 is similar to the system 1400 shown in FIG. 14 except that there are multiple media inputs instead of only one as in the system 1400. In the example shown in FIG. 17, there are three independent media files 1722, 1724, and 1726.

The segmenter 150 in the computing device 110 may segment the three media files according to a pre-determined data formatting scheme or patter. This data formatting scheme or pattern is also known by the receiver side via the mobile device 905. The mobile device 905 may recover one of the media file or all three media files. It may store the recovered media files in appropriate local buffers 850 (in FIG. 9).

The data format scheme using a sample basis or a block basis may be used in the system 1700. In the following, the data formatting scheme is further described.

Suppose S1, S2, and S3 are three 2-D photos; each featuring 1200×1800 pixels. The 3 complex input pixels to the K-Muxing 160 are formulated pixel-by-pixel in three pixel streams. The K-muxing 160 transforms these pictures pixel-by pixel or sample-by-sample. In a first scenario where processing samples is chosen to be photo pixels featuring 8-bit numbers. A stream of pixels for a picture with 1200×1800 pixels comprises 1800 lines and each line further comprising 1200 pixels each with an 8-bit byte. There are 1200 bytes per line at the 3 inputs. For a first pixel line, we shall perform 1200 transforms in series of K-muxing 160 from 3 input photos; generating 4 first lines on 4 different output files. Each of the 3 first input lines features 1200 8-bit samples while each of the 4 output first line 1201 8-bit samples. The extra sample is due to overflow from cascaded arithmetic operations. As a result, the 3 photos with 1200×1800 pixels each are transformed into 4 individual sets of 1201×1800 pixels by the K-muxing 160. There are 2,160,000 times K-muxing operations in converting the 3 pictures into a first group of 4 K-muxed data sets.

In similar scenarios, processing samples may be chosen to be different from photo pixels. We may use multiple (M) pixels as a processing sample where M is an integer and M>1. Suppose a pixel intensity of a photo under these scenarios is indicated by an 8-bit byte for a dynamic range of ˜48 dB. More specifically, a 2-D photo format of 1200×1800 pixels in a pixel-by-pixel stream can be converted to 2-D 600×900 samples in a sample-by-sample stream. A “sample” in the chosen format comprising an assembly of (2×2) pixels feature a 4-byte numerical number. Each input picture shall feature 900 lines and 600 samples per line at the 3 inputs. For a first “sample” line, we shall perform 600 transforms in series of K-muxing 130 from 3 input photos; generating 4 first lines on 4 different output files. Each of the 3 first input lines features 600 4-bit samples while each of the 4 output first line 601 4-byte samples. The extra sample is due to overflow from cascaded arithmetic operations. As a result, the 3 photos with 1200×1800 pixels each are converted into 600×900 samples first, and then transformed into 4 individual sets of 601×900 samples by the K-muxing 130. There are 540,000 times K-muxing operations in converting the 3 pictures into a second group of 4 K-muxed data sets.

In general, the first and the second groups of the K-muxed data sets shall be different even both originated from the same sets of original pictures, [S1, S2, and S3], and transform of the K-muxing 160 performs the same functions. This is mainly due to differences the numerical formats of chosen processing samples.

In a different embodiment using a block basis, refer to FIG. 17 again. The processing samples may vary in their numerical format. More specifically, the K-muxing 160 transform feature identical samples format among 3 input photos, S1(t), S2(t), and S3(t), and the sample format for all three may varies from nth sample-transform to the N=1 sample transform. A 2-D photo format of 1200×1800 pixels in a pixel-by-pixel stream for each input can be converted to 936 blocks in which 933 A-blocks featuring 23 pixels each and the remaining 3 B-blocks with 47 pixels each. The total 21600 pixels or (933*23+3*47) pixels for each of the 3 inputs of the K-muxing 160 will become 22536 pixels or (933*24+3*48) pixels in each of the 4 outputs. A block with 23 pixels from the pixel-by-pixel stream are segmented into three samples, each with interlaced pixels; as follows; first 12 pixels are assigned as [a1, b1, c1, a2, b2, c2, a3, b3, c3, a4, b4, c4] and second 11 pixels are assigned to [a5, b5, c5, a6, b6, c6, a7, b7, c7, a8, b8]. The three samples [A] [B] [C] are [A]=[a1, a2, a3, a4, a5, a6, a7, a8], [B]=[b1, b2, b3, b4, b5, b6, b7, b8], and [C]=[c1, c2, c3, c4, c5, c6, c7].

A block-to-block transform comprises multiple sample-to sample transforms in sequence to minimize numbers of required overflow/underflow bytes or “overflow pixels” in the numerical operations in the transforms in outputs. These are a part of data size overhead in the K-muxing 160 operations. In this example, we use two types of blocks for this operation; A-blocks with 23 pixels each, and B-blocks with 47 pixels each. In a block-by-block operation, the types of blocks among the three inputs must be identical concurrently.

In other operation with the same inputs we may choose more than two types of block transforms, as long as they are parts of the agreed processing data formats known to the user community a priori. A source and corresponding destinations use a same and agreed “block sequence” or data format scheme in performing the K-muxing and the corresponding K-demuxing transforms.

Alternatively, the 23 pixel block in a pixel-by-pixel stream, say S1(t), are segmented into three samples, each with contiguous pixels; as follows; first 12 pixels are assigned as [a1, a2, a3, a4, a5, a6, a7, a8, b1, b2, b3, b4], while second 11 pixels are assigned as [b5, b6, b7, b8, c1, c2, c3, c4, c5, c6, c7].

In a 2^{nd} alternative, each of the 23 pixel blocks for 3 consecutive 3-to-4 K-muxing 160 transforms will be assigned differently among the three inputs S1(t), S2(t), and S3(t) as followed; S1(t) in the three consecutive transforms featuring [7, 8, 8] pixels, S2(t) in [8, 7, 8] pixels, and S3(t) with [8, 8, 7] pixels. The 4 outputs shall feature 4 concurrent blocks each with 24 pixels.

Accordingly, the associated K-demuxing 560 use identical data formatting scheme for selected processing samples as those in the transforms of corresponding K-muxing 160.

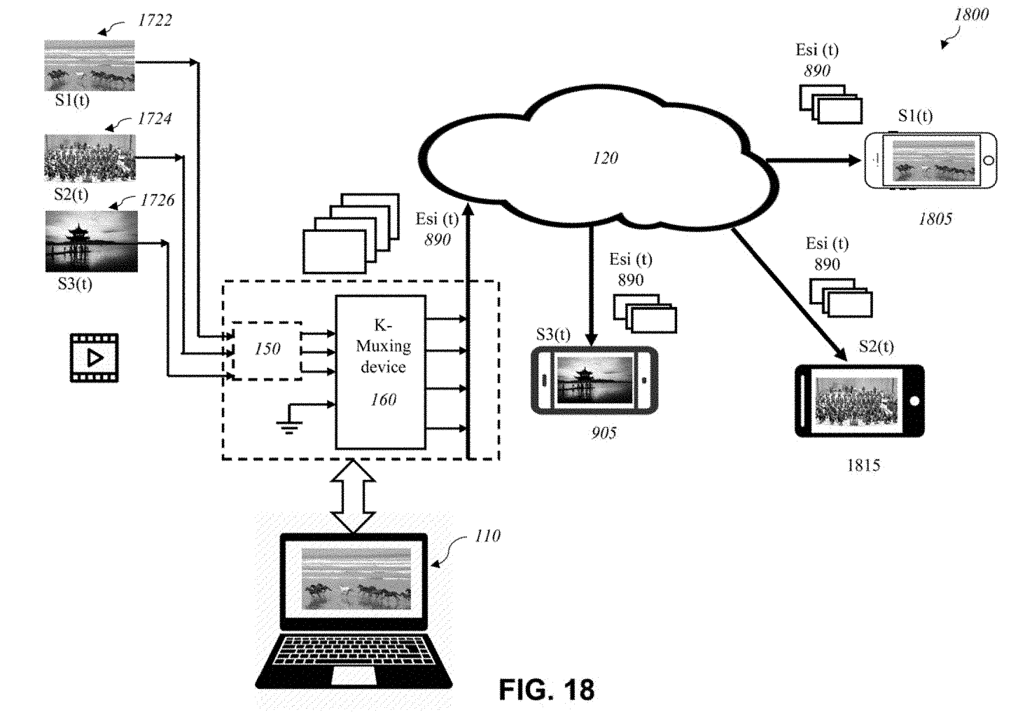

FIG. 18 is a diagram illustrating a system 1800 having multiple media inputs at the transmitter side and multiple media outputs at the receiver side and using mobile devices with WF muxing and de-muxing and 3-for-4 redundancy according to one embodiment. The system 1800 is similar to the system 1700 except that there are three mobile devices 905, 1805, and 1815 instead of only one mobile device 905 as in the system 1700.

The 3 original media inputs, S1, S2, and S3 are 3 independent short video clips 1722, 1724, and 1726. The data recording or writing process is identical to that in FIG. 17.

There are three reading users using the mobile devices 905, 1805, and 1815. Each of the three mobile devices retrieves designated media files. For example, the mobile device 905 retrieves the media files 890 corresponding to the media file S3(t) 1726, the mobile device 1805 retrieves the media files 890 corresponding to the media file S1(t) 1722, and the mobile device 1815 retrieves the media files 890 corresponding to the media file S3(t) 1726.

K-Muxing via Erasure Code:

K-muxing of data storage techniques feature enhanced privacy and survivability via redundancy for stored data. For many applications with large data storage, data survivability is a key important criteria while data privacy is not as critical. Assume that a stored data set with a total of N files having N-P primary files and P redundant files or parity files. In these applications, the original inputs to a K-muxing transform will be used as primary files in a stored data set and corresponding outputs from the K-muxing may be selected as redundant files or parity files of the stored data set. As an example, a large data file S is segmented into 8 segments S1 to S8, which are connected to an 8-to-8 K-muxing transformation with 8 outputs Y1 to Y8. The segmented data files S1 to S8 will be used as primary files in a storage data set, while redundant or parity files of the stored data set may be selected from the 8 outputs Y1 to Y8. The 8-to-8 K-muxing provides 8 additional parity files, in which we may choose 2 only for some applications supporting a 1.25× total storage constraint but with limited survivability protection. For other applications with enhanced survivability which need a 2× storage, we may take all 8 outputs as a set of parity files.

Erasure coding (EC) is a method of data protection in which data is broken into fragments, expanded and encoded with redundant data pieces and stored across a set of different locations or storage media. In general, most of K-muxing transforms are linear processing while most of erasure coding (EC) are not. However, when keeping |X|=1 in EC polynomials, the selected EC process can be made to function as linear processing. The unique features in the overlapped domain of K-muxing and EC are explored in the following.

Redundant array of independent disks (RAID) uses checksums or mirroring to protect data, and spreads the data and checksums across a group of disks. Using available terabyte disk drives, it is common to manage data sets on a single, consistent logical RAID volume of 4-12 drives with a total usable capacity of about 30 terabytes. RAID slices data into a fixed number of data blocks and checksums, and writes each chunk or checksum onto an independent disk in the volume. However, higher capacity disks used to build these large RAID volumes for digital libraries with high-resolution content also dramatically lengthen the rebuild time when failures occur. In addition, dual and triple parity RAID can mitigate the risk of data corruption, but adding additional parity checks is costly and reduces RAID performance, so it is less and less attractive as the storage scales. Furthermore, without replication, RAID offers limited protection against node-level failures, and no protection against site-level disasters. But it is expensive. It doubles the amount of storage required, requires expensive high-bandwidth networking between the sites, and introduces new operational complexities to ensure the replication is performing properly or to keep both sites accurately synchronized.

On the other hand, erasure code algorithms were developed decades ago to ensure transmission integrity of streaming data for space communications. In information theory, an erasure code is a forward error correction (FEC) code for the binary erasure channel, which transforms a message of k symbols into a longer message (code word) with n symbols such that the original message can be recovered from a subset of the n symbols. The fraction r=k/n is called the code rate, the fraction k′/k, where k′ denotes the number of symbols required for recovery, is called reception efficiency.

Optimal erasure codes have the property that any k out of the n code word symbols are sufficient to recover the original message (i.e., they have optimal reception efficiency). Optimal erasure codes are maximum distance separable (MDS) codes. Optimal codes are often costly On terms of memory usage, CPU time, or both) when n is large. Except for very simple schemes, practical solutions usually have quadratic encoding and decoding complexity.

Erasure coding transforms data objects into a series of codes. Each code contains the equivalent of both data and checksum redundancy. The codes are then dispersed across a large pool of storage devices, which can be independent disks, independent network-attached storage nodes, or any other storage medium. While each of the codes is unique, a random subset of the codes can be used to retrieve the data. The erasure code algorithms that spread the data to protect it also make upgrading to new storage technologies simpler. When drives fail, the object storage redistributes the protection codes without having to replace disks and without degrading user performance. Administrators are now free to schedule drive replacement at their convenience, and are free to upgrade to larger disk sizes. Unlike RAID, codes can be spread across racks or geographically dispersed sites without replication, allowing erasure coding to protect from disk, node, rack, or even site failures all on the same scalable system. The algorithms can also apply different durability policies within the same object storage so that critical data can be given greater data protection without segregating it at the hardware level.

ReedSolomon (RS) codes are an important group of error-correcting codes. They have many important applications, the most prominent of which include consumer technologies such as CDs, DVDs, Blu-ray Discs, QR Codes, data transmission technologies such as DSL and WiMAX, broadcast systems such as DVB and ATSC, and storage systems such as RAID 6. They are also used in satellite communication. In coding theory, the ReedSolomon code belongs to the class of non-binary cyclic error-correcting codes. The ReedSolomon code is based on univariate polynomials over finite fields. It is able to detect and correct multiple symbol errors. By adding t check symbols to the data, a ReedSolomon code can detect any combination of up to t erroneous symbols, or correct up to [t/2] symbols. As an erasure code, it can correct up to t known erasures, or it can detect and correct combinations of errors and erasures. Furthermore, ReedSolomon codes are suitable as multiple-burst bit-error correcting codes, since a sequence of b+1 consecutive bit errors can affect at most two symbols of size b. The choice oft is up to the designer of the code, and may be selected within wide limits.

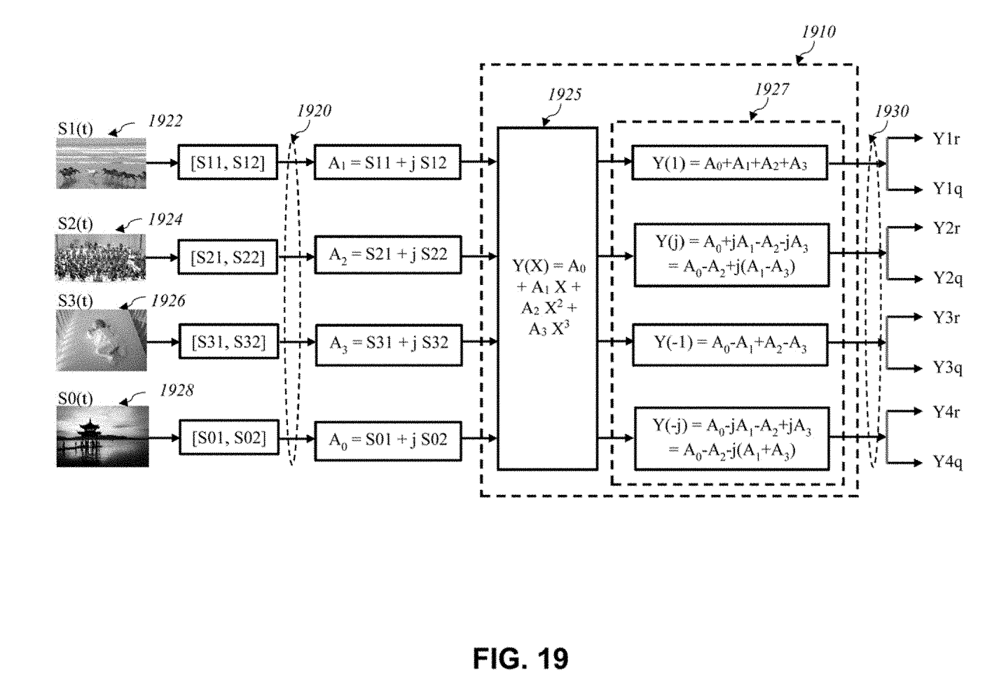

FIG. 19 is a diagram illustrating a processing device using a polynomial for generating Reed-Solomon (RS) code as a K muxing process with multiple media input files according to one embodiment.

In large-data storage RS codes as optimum erasure codes have been used for better survivability via redundancy. FIG. 19 depicts a block diagram using a polynomial 1925 for RS code of, as a version K-muxing 1910 among 4 photo files.

Y(X)=A₀+A₁X+A₂X²+A₃X³ (17)

where [A₀] are inputs for pixels of S0 which are converted as a pixel stream S0(t), [A₁] are inputs for pixels of S1 which are converted as a pixel stream S1(t), [A₂] are inputs for pixels of S2 which are converted as a pixel stream S2(t), [A₃] are inputs for pixels of S3 which are converted as a pixel stream S3(t), [A₀, A₁, A₂, A₃] are the 4 inputs 1920 of a K-muxing 1910.

In fact, over the finite field of selected X variables [X1, X2, X3, X4], X⁴ always equals to 1. Thus Equation (17) can be re-written as

Y(X)=A₁X+A₂X²+A₃X³+A₄X⁴ (18)

and A₄=A₀.

In addition, each of the four pictures with pixels in real number is segmented into two groups, S1=[S11, S12], S2=[S21, S22], S3=[S31, S32], S0=[S01, S02]. As an example, when S1 is a picture with 8 M-pixels; then each of S11 and S12 features 4 M pixels. A first input to the RS polynomial 128, [A₁], mathematically features a stream of complex number with intensity of a pixel in S11 as the real part and intensity of a corresponding pixel in S12 as the imaginary part; or the nth sample of the A₁ stream is represented as A₁(n)=S11(n)+j S12(n); or simply

A₁=S11+j S12 (19-1).

Similarly, A₂=S21+j S22 (19-2)

A₃=S31+j S32 (19-3)

A₀=S01+j S02 (19-4)

Furthermore, we extend a finite field for the polynomial of variable X over a unity circle in a complex plane. X varies among the 4 points of a unity circle over a complex plane, and X1=1+j 0, X2=0+j 1, X3=−1+j 0, X4=0−j 1. Thus the outputs of the polynomial 1925 at the 4 different Xs (X=X1, X=X2, X=X3, and X=X4) are written as

Y(X1)=Y(1)=A₀+A₁+A₂+A₃ (20-1)

Y(X2)=Y(j)=A₀+jA₁−A₂−jA₃ (20-2)

Y(X3)=Y(1)=A₀−A₁+A₂−A₃ (20-3)

Y(X4)=Y(j)=A₀−jA₁−A₂+jA₃ (20-4).

Using the terminologies of wavefront multiplexing (WF muxing) for the K-muxing 1910, the 4 data streams A₀, A₁, A₂, A₃ of the 4 inputs 1920 are, respectively, distributed over the 4 selected output files 1930 with different sets of weighting components. Each distributed set over the four outputs 1930 corresponds to one of the 4 inputs 1920 is referred as a wavefront characterized by a wavefront vector (WFV). The 4 WFVs are WFV0 for input data stream A₀, WFV1 for data stream A₁, WFV2 for data stream A₂, WFV3 for data stream A₃, where

WFV0=[1, 1, 1, 1]^{T}, (21-1)

WFV1=[1, j, 1, −j]^{T}, (21-2)

WFV2=[1, −1,1, −1]^{T}, (21-3)

WFV3=[1, −j, 1, j]^{T}, (21-4)

It is noted that equations (20-1), (20-2), (20-3), and (20-4) are formulations for a 4-to-4 FFT. When the polynomial 1925 becomes a mechanism generating 4-point FFT between the domain of [A's] to the domain of [Y's] when the 4 sampling points of X in a complex plane (or a I-Q plane) are chosen to be at X=Xi where i=1 to 4; and X1=1+j 0, X2=0+j 1, X3=−1+j 0, and X4=0−j 1.

The four outputs 1930 feature 4 sample streams of complex number or 8 real sample streams;

Y(1)=Y1r+j Y1q (22-1)

Y(j)=Y2r+j Y2q (22-2)

Y(1)=Y3r+j Y3q (22-3)

Y(−j)=Y4r+j Y4q (22-4)

and

Y1r=S01+S11+S21+S31 (23-1)

Y1q=S02+S12+S22+S32 (23-2)

Y2r=S01−S12−S21+S32 (23-3)

Y2q=S02+S11−S22−S31 (23-4)

Y3r=S01−S11+S21−S31 (23-5)

Y3q=S02−S12+S22−S32 (23-6)

Y4r=S01+S12−S21−S32 (23-7)

Y4q=S02+S11−S22−S31 (23-8)

Equations (22-1) to (22-4) and equations (23-1) to (23-8) can be written in form of a matrix as that in equation (24).

$$[ \begin{matrix}Y 1 r \\ Y 1 q \\ Y 2 r \\ Y 2 q \\ Y 3 r \\ Y 3 q \\ Y 4 r \\ Y 4 q\end{matrix} ] = [ \begin{matrix}1 & 0 & 1 & 0 & 1 & 0 & 1 & 0 \\ 0 & 1 & 0 & 1 & 0 & 1 & 0 & 1 \\ 1 & 0 & 0 & - 1 & - 1 & 0 & 0 & 1 \\ 0 & 1 & 1 & 0 & 0 & - 1 & - 1 & 0 \\ 1 & 0 & - 1 & 0 & 1 & 0 & - 1 & 0 \\ 0 & 1 & 0 & - 1 & 0 & 1 & 0 & - 1 \\ 1 & 0 & 0 & 1 & - 1 & 0 & 0 & - 1 \\ 0 & 1 & 1 & 0 & 0 & - 1 & - 1 & 0\end{matrix} ] [ \begin{matrix}S 01 \\ S 02 \\ S 11 \\ S 12 \\ S 21 \\ S 22 \\ S 31 \\ S 32\end{matrix} ] \qquad ( 24 )$$

In reconstructing S0 to S3, there are 8 unknowns (S01 to S32) with 8 equations relating 8 Y's (stored data files) and 8 S's (segmented substreams from an original information data). There is no redundancy in FIG. 19 for the stored data while using conventional K-muxing methods featuring data privacy. In order to reconstruct the 8 S's (segmented substreams from the original information data), we will need all 8 Y's (stored data files). For applications where privacy is not critical in a stored data set, we may use all the input files, the 8 S's (segmented substreams from an original information data), as the primary storage files while the redundancy or parity files may be selected from the 8 Y's.

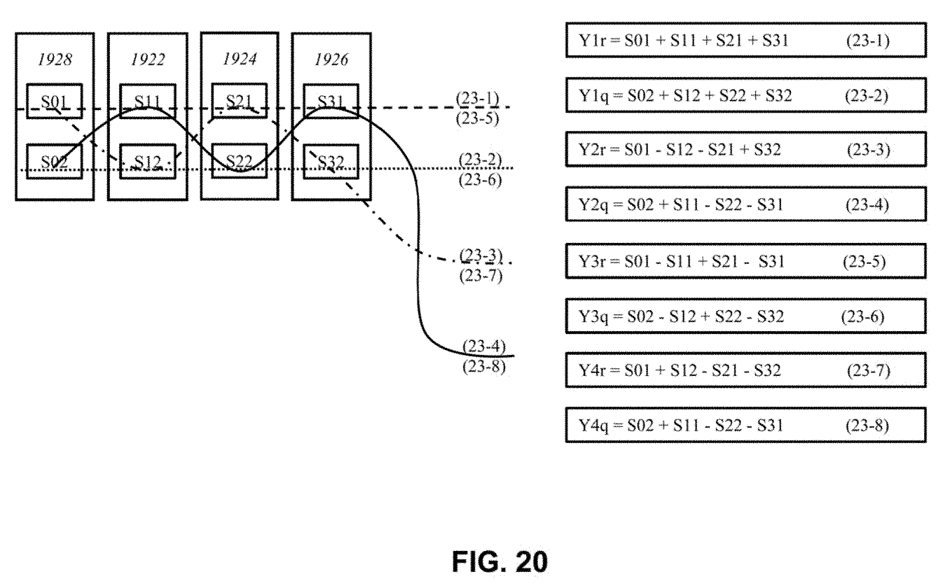

FIG. 20 is a diagram illustrating outputs as linear combinations of inputs according to one embodiment.

It is noted that each output in the equations is a linear combination of 4 of the 8 S's only. More specifically as indicated in FIG. 20, Equations (23-1) and (23-5) aggregate 4 inputs of pixel streams together via two linear combinations, respectively, of the real parts of the 4 complex inputs 1920. Equations (23-2) and (23-6), respectively via the two linear combinations, depict the processing of combining 4 pixel streams of the imaginary parts of the 4 complex inputs 1920. The other 4 equations 23-3, 23-4, 23-7 and 23-8 show the 4 respective linear combinations of 4 pixel streams related to the real parts of 2 complex inputs 1920 and the imaginary parts of the other 2 remaining complex inputs 1920.

In many other embodiments, the 8 segmented inputs (S01 to S32) will be used as storage data sets, and the 8 outputs (Y1r to Y4q) as redundancy or as parity files. The 8 inputs 1920 may be data sub-files segmented from a single large file, 8 independent files, combinations of multiple (N) sub-files from a first large file and multiple (8-N) sub-files from a second large file, or combinations of multiple (N) sub-files from a third large file and multiple (8-N) other independent files. The process of utilizing the polynomial 1925 in FIG. 19 will provide 8 additional parity files, in which we may choose 2 only for some applications which support a 1.25× total storage but with limited survivability protection. For other applications with enhanced survivability which need a 2× storage, we may take all 8 outputs as a set of parity files.

In short, the K-muxing 1910 features 4 inputs 1920 and 4 outputs 1930. These inputs and outputs are complex data streams, each of which can be re-written as two real pixel substreams. Therefore, the K-muxing 1910 effectively performs a transformation with 8-real inputs and 8-real outputs.

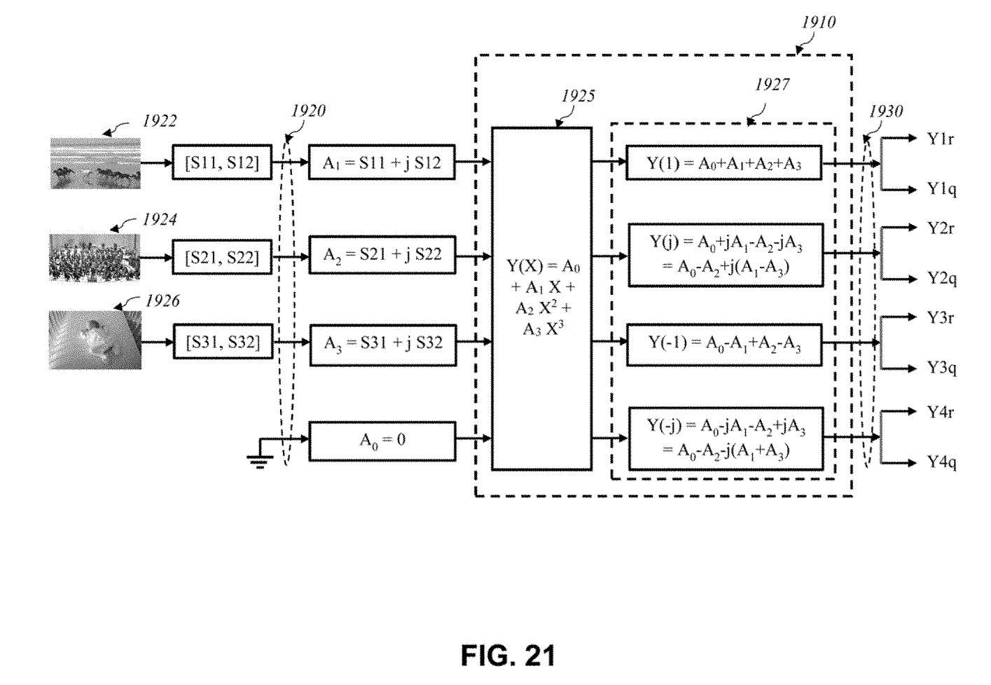

FIG. 21 is a diagram illustrating a processing device using a polynomial for generating Reed-Solomon (RS) code as a K muxing process with multiple media input files having one grounded input according to one embodiment.

FIG. 21 depicts a configuration nearly identical to that shown in FIG. 19 except one of inputs to the K-muxing 1910 is grounded. Both parts of S0 inputs, S01 and S02, are set to zero. We keep the polynomial 1925 the same as that in FIG. 19 and operated in the domain only of X=[X1, X2, X3, X4], where X1=1, X2=j, X3=−1, and X4=−j. The three remaining inputs, S1 1922, S2 1924 and S3 1926, are segmented separately into [S11, S12], [S21, S22], [S31, S32], respectively. The 4 complex inputs to the K-Muxing 1910 are formulated pixel-by-pixel or sample-by-sample in the pixel streams according to equation (19-1) to (19-4). More specifically, in a format of sample-by-sample in the pixel streams for the 4 inputs, A1=S1=S11+j S12, A2=S2=S21+jS22, A3=S3=S31+jS32, and A4=S0=0.

Under these conditions, equations (23-1) to (23-8) become

Y1r=S11+S21+S31 (25-1)

Y1q=S12+S22+S32 (25-2)

Y2r=−S12−S21+S32 (25-3)

Y2q=S11−S22−S31 (25-4)

Y3r=−S11+S21−S31 (25-5)

Y3q=−S12+S22−S32 (25-6)

Y4r=S12−S21−S32 (25-7)

Y4q=S11−S22−S31 (25-8)

There are total 6 inputs (segmented inputs from 3 pictures) but with 8 outputs via 8 equations. It is certain that the 8 outputs are not independent. There may be as many as 2 redundant equations for operation using input formats in sample-by-sample in the pixel streams. In reconstructing S1 to S3, there are 6 unknown (S11 to S32) with 8 equations relating 8 Y's (stored data files) and 6 S's (segmented substreams from 3 original photo data). There are two redundancy in FIG. 21 for the stored data while using conventional K-muxing methods featuring both data privacy and redundancy. In order to reconstruct the 6 S's (segmented substreams from the 3 original photos), we will need any 6 from all 8 Y's (stored data files). For applications where privacy is not critical in a stored data set, we may use all the input files, the 6 S's (segmented substreams from an original information data), as the primary storage files while the redundancy or parity files may be selected from the 8 Y's.

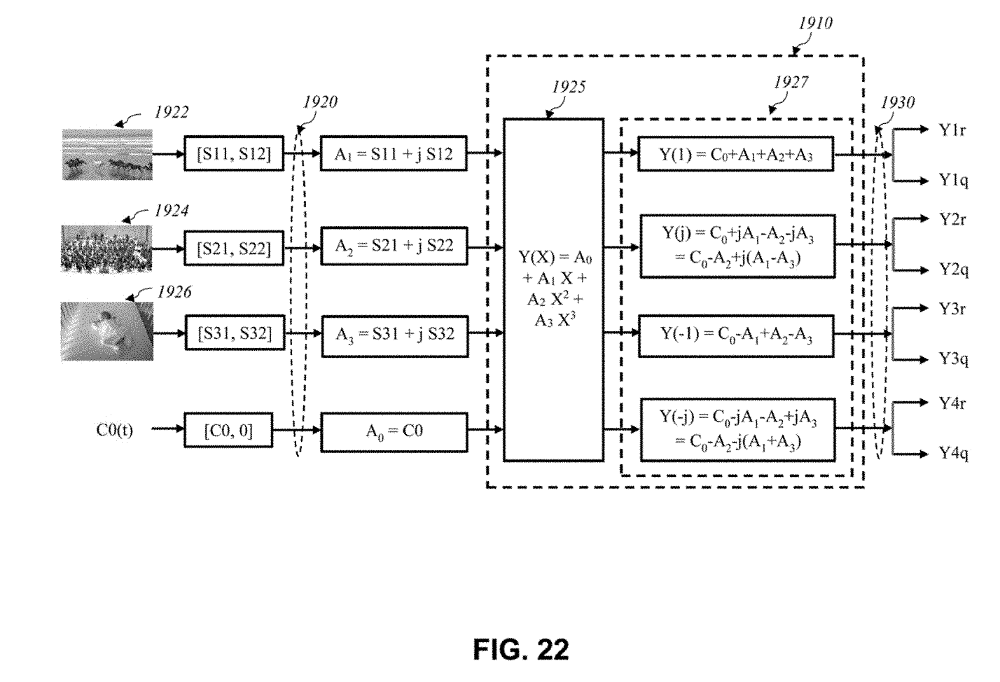

FIG. 22 is a diagram illustrating a processing device using a polynomial for generating Reed-Solomon (RS) code as a K muxing process with multiple media input files having one auxiliary input according to one embodiment.

FIG. 22 depicts a configuration also nearly identical to that shown in FIG. 19 except one of inputs to the K-muxing 1910 is a known digital file for authentication, diagnostic or/and an excess key. One of the two parts of S0 inputs, S01 and S02, is set to zero; S0=[C0, 0]. We keep the polynomial 1925 the same as that in FIG. 19 and operated in the domain only of X=[X1, X2, X3, X4], where X1=1, X2=j, X3=−1, and X4=−j. The three remaining inputs, S1 1922, S2 1924 and S3 1926, are segmented separately into [S11, S12], [S21, S22], [S31, S32], respectively. The 4 complex inputs to the K-Muxing 1925 are formulated pixel-by-pixel or sample-by-sample in the pixel streams according to equation (19-1) to (19-4). More specifically in a format of sample-by-sample in the pixel streams for the 4 inputs, A1=S1=S11+j S12, A2=S2=S21+j S22, A3=S3=S31+j S32, and A4=S0=C0.

Under these conditions, equations (23-1) to (23-8) become:

Y1r=C0+S11+S21+S31 (26-1)

Y1q=0+S12+S22+S32 (26-2)

Y2r=C0−S12−S21+S32 (26-3)

Y2q=0+S11−S22−S31 (26-4)

Y3r=C0−S11+S21−S31 (26-5)

Y3q=0−S12+S22−S32 (26-6)

Y4r=C0+S12−S21−S32 (26-7)

Y4q=0+S11−S22−S31 (26-8)

There are total 7 inputs (segmented inputs from 3 pictures) but with 8 outputs via 8 equations. It is certain that the 8 outputs are not independent. There may be a redundant equation for operation using input formats in sample-by-sample in the pixel streams. In reconstructing S1 to S3 to a user community where C0 is known to them, there are 6 unknowns (S11 to S32) with 8 equations relating 8 Y's (stored data files) and 6 S's (segmented substreams from 3 original photo data). There are two redundancy in FIG. 22 for the stored data while using conventional K-muxing methods featuring both data privacy and redundancy. In order to reconstruct the 6 S's (segmented substreams from the 3 original photos), we will need any 6 from all 8 Y's (stored data files).

On the other hand, in reconstructing S1 to S3 to a user community where C0 is not known to them, there are 7 unknowns (C0 and S11 to S32) with 8 equations relating 8 Y's (stored data files) and C0 as well as 6 S's (segmented substreams from 3 original photo data). There is one redundancy in FIG. 22 for the stored data while using conventional K-muxing methods featuring both data privacy and redundancy. In order to reconstruct the 6 S's (segmented substreams from the 3 original photos), we will need any 7 from all 8 Y's (stored data files).

In some scenarios where only 6 of the stored Ys are available in reconstructing S1 to S3 to a user community where C0 is known to them, there are 6 unknowns (S11 to S32) with 6 equations relating 6 available Y's (stored data files) to 6 S's (segmented substreams from 3 original photo data). The 6 S's can then be reconstructed.

For applications where privacy is not critical in a stored data set, we may use all the input files, the 6 S's (segmented substreams from an original information data), as the primary storage files while the redundancy or parity files may be selected from the 8 Y's.

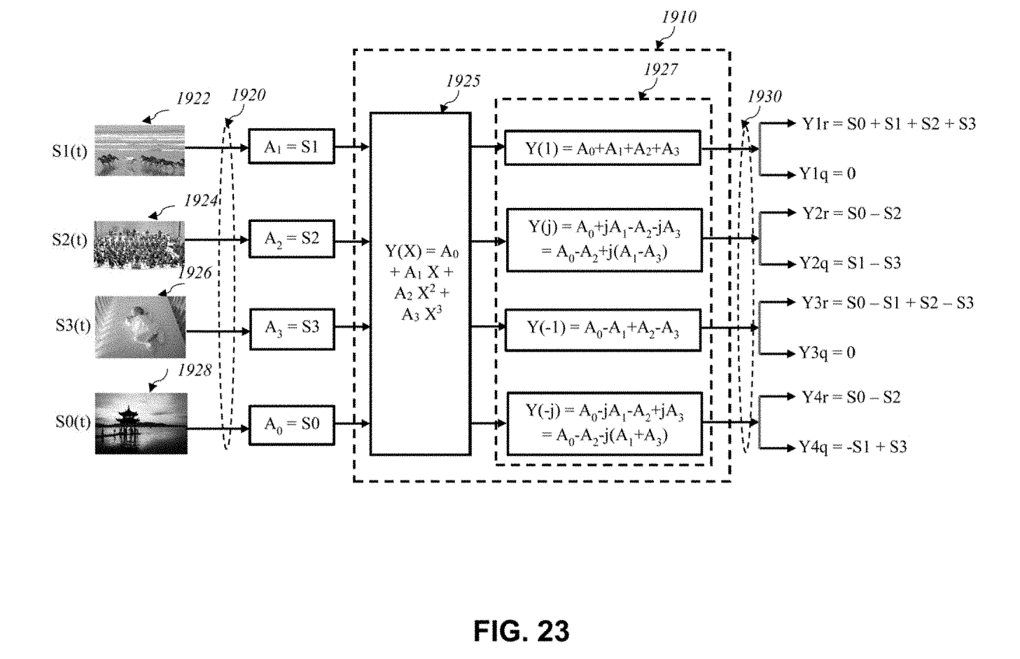

FIG. 23 is a diagram illustrating a processing device using a polunomial for generating Reed-Solomon (RS) code as a K nuxing process with multiple media input files in complex number format according to one embodiment.

FIG. 23 depicts a configuration also nearly identical to that shown in FIG. 19 except all inputs in complex number formats to the K-muxing 1910 are connected to digital streams representing “real” numbers. The imaginary parts of the inputs are set to zeros; so that S1=[S1, 0], S2=[S2, 0], S3=[S3, 0], and S0=[S0, 0]. We keep the polynomial 1925 the same as that in FIG. 19 and operated in the domain only of X=[X1, X2, X3, X4], where X1=1, X2=j, X3=−1, and X4=−j. The 4 inputs to the K-Muxing 1910, S1 1922, S2 1924, S3 1926, and S0 1928 are formatted into 4 separated pixel streams, respectively. The 4 complex inputs are formulated pixel-by-pixel or sample-by-sample in the pixel streams according to equation (19-1) to (19-4). More specifically, in a format of sample-by-sample in the pixel streams, the 4 inputs are set so that A1=S1, A2=S2, A3=S3, and A4=S0.

Under these conditions, equations (23-1) to (23-8) become:

Y1r=S0+S1+S2+S3 (27-1)

Y1q=0+0+0+0=0 (27-2)

Y2r=S0−0−S2+0 (27-3)

Y2q=0+S1−0−S3 (27-4)

Y3r=S0−S1+S2−S3 (27-5)

Y3q=0−0+0−0=0 (27-6)

Y4r=S0+0−S2−0 (27-7)

Y4q=0+S1−0−S3 (27-8)

There are total 4 inputs (real number inputs from 4 pictures) but with 8 outputs via 8 equations. Two of them, (27-2) and (27-6) are zeros, and another two pairs [(27-3), (27-4)] and [(27-7), (27-8)] are identical. As a result, the remaining are 4 independent outputs. In reconstructing S1, S2, S3 and S0 to a user community where S0 is used as a file for diagnostic, authentications, or/and identification key and known to them, there are 3 unknowns (S1 to S3) with 4 equations relating 4 Y's (stored data files) and 3 S's (streams from 3 original photo data). There is a redundancy in FIG. 23 for the stored data while using conventional K-muxing methods featuring both data privacy and redundancy. In order to reconstruct the 3 S's (segmented substreams from the 3 original photos), we will need any 3 from all 4 Y's (stored data files).

On the other hand, in reconstructing S1 to S3 to a user community where S0 is not known to them, there are 4 unknowns (S0 and S1 to S3) with 4 equations relating 4 Y's (stored data files) to S0 as well as 3 S's (streams from 3 original photo data). There is no redundancy in FIG. 23 for the stored data while using conventional K-muxing methods featuring only data privacy.

In some scenarios where only 3 of the 4 stored Ys are available in reconstructing S1 to S3 to a user community where S0 is known to them, there are 3 unknowns (S1 to S3) with 3 equations relating 3 available Y's (stored data files) to 3 S's (streams from 3 original photo data). The 3 S's can then be reconstructed.

For applications where privacy is not critical in a stored data set, we may use all the input files, the 4 S's (streams from an original information data), as the primary storage files while the redundancy or parity files may be selected from the 4 Y's.

FFT, Butler Matrix and Array Radiation Patterns:

The polynomial 1925 in FIG. 19 generating 4-to-4 FFT, the X variable is selected over a finite field of [X] on the unity circle in a complex plane; where the adjacent X-samples are spaced by a rotation of π/2. We shall examine the formulation in terms of radiation patterns of a 4 element array with a uniform element spacing of a half wavelengths. The weighting parameters between the output [Y's] and the [A's] in the four linear Equations (20-1) to (20-4) are tabulated in Table 1, and the corresponding phases and phase progressions of the weighting parameters are in Table 2.

TABLE 1

complex weighting parameters

| X | Y (X) | A0 | A1 | A2 | A3 |
|---|---|---|---|---|---|
| X1 = 1 | Y (1) | 1 | 1 | 1 | 1 |
| X2 = j | Y (j) | 1 | j | −1 | −j |
| X3 = −1 | Y (−1) | 1 | −1 | 1 | −1 |
| X4 = −j | Y (−j) | 1 | −j | −1 | j |

TABLE 2

| | phases of weights (deg.) | | | | | |
|---|---|---|---|---|---|---|
| X | Y (X) | A0 | A1 | A2 | A3 | Δϕ (deg) |
| X1 = 1 | Y (1) | 0 | 0 | 0 | 0 | 0 |
| X2 = j | Y (j) | 0 | 90 | 180 | 270 | 90 |
| X3 = −1 | Y (−1) | 0 | 180 | 360 | 180 | 180 |
| X4 = −j | Y (−j) | 0 | −90 | −180 | −270 | −90 |

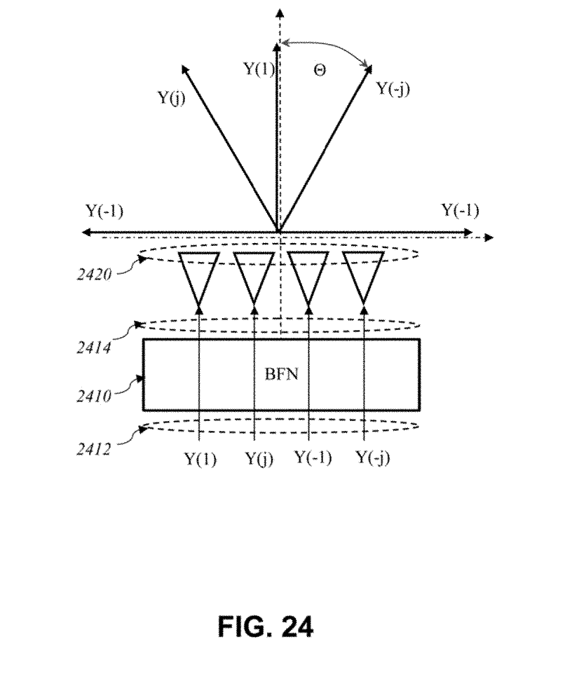

FIG. 24 is a diagram illustrating geometry of an array forming multiple beams according to one embodiment.

For an array forming multiple beams, the corresponding geometries are shown in FIG. 24. The transmitting linear array features 4 radiating elements 2420 with a uniform spacing of half wavelength. The beam forming network (BFN) 2410, implemented with functions of those of a 4-to-4 FFT, features 4 inputs 2412 and 4 outputs 2414. A first inputs is fed by a stream of data of Y(1). Similarly, a 2^{nd}, a 3^{rd}, and a 4^{th} inputs are respectively connected to 3 other data streams indicated as Y(j), Y(−1), and Y(−j). These 4 streams of data are radiated concurrently from all 4 elements 2420 of the transmitting array.

The BFN 2410 is programmed or configured to generated four orthogonal wavefronts WFV0, WFV1, WFV2, and WFV3; where

WFV0=[1, 1, 1, 1]^{T}, (21-1)

WFV1=[1, j, 1, −j]^{T}, (21-2)

WFV2=[1, −1, 1, −1]^{T}, (21-3)

WFV3=[1, −j, 1, j]^{T}, (21-4)

and

¼WFVi,^{T}×WFCj*=0 when i≠j (28-1)

¼WFVi,^{T}×WFVj*=1 when i=j (28-2)

Their relative phases are tabulated in Table 2. Y(1) is riding the first wavefront WFV0 corresponding to a beam with a beam peak at the boresight or θ=0° indicated by the arrow direction of Y(1). We refer the direction of the beam peak as the pointing direction. The 2^{nd} beam and the 4^{th} beam generated by the BFN 2410 for the Y(j) and Y(−j) streams, respectively, feature a beam pointing direction at θ=30 degrees and θ=−30 degrees. The 3^{rd} beam generated by the BFN 2410 for the Y(−1) stream features two beam pointing directions at θ=90 degrees and θ=−90 degrees. In fact, the peak at θ=−90 degrees is a grating lobe of the main beam at θ=90 degrees.

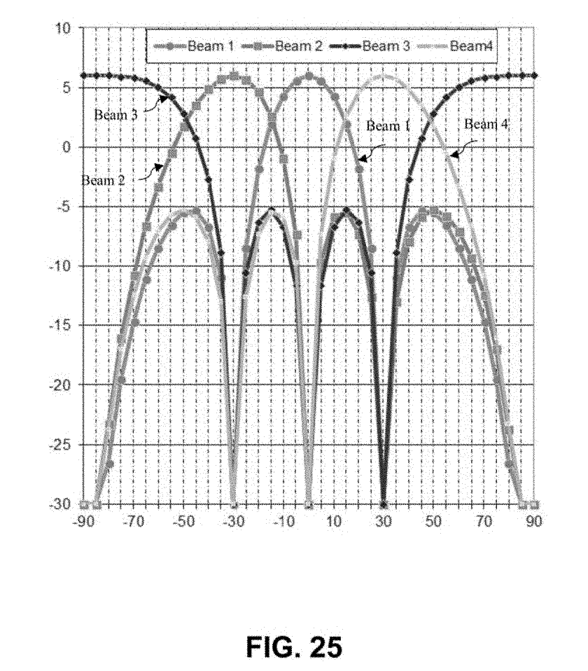

FIG. 25 is a diagram illustrating array gain vs. azimuth angle for four radiation patterns according to one embodiment.

The simulated results array gain vs azimuthal angle θ for the four radiation patterns are depicted in FIG. 25. The vertical axis are relative radiated power levels of antenna gain in dB, and the horizontal axis shows azimuthal angles θ in degrees. Beam 1 for Y(1) data stream is pointed at the boresight, or θ=0°, beam 2 for Y(j) data stream is pointed at the direction of θ=−30° and beam 4 for Y(j) data stream is pointed at the direction of θ=30°. It is also indicated that beam 3 actually is pointed in both ±90° away from the boresight; the end-fire directions.

Furthermore, the four beams feature unique orthogonal beam (OB) radiation patterns. Among the 4 OB beams, a peak of one beam is always at a direction which is aligned exactly with nulls of radiation patterns of other 3 OB beams. An OB beam features a radiation pattern with nulls in the directions always aligned with the peaks of other 3 OB beams. As an example, the OB beam for Y(1) or Beam 1 features a peak at θ=0° which is also in the direction of a null of all 3 other beams, Beam 2 for Y(j), Beam 3 for Y(−1), and Beam 4 for Y(−j).

For the data storage applications, data at the outputs of the BFN 2410, which are wavefront multiplexed or K-muxed, is stored over distributed storage. Data retrievals are via “propagation via space” performing wavefront demultiplexing or K-demuxing. The propagation via space will be in forms of software emulations.

For antenna engineers, it is common to refer the pointing directions in a UV coordinates. For a one-dimension scan linear array, various pointing directions may be shown in different values of u; where u=sin θ. When θ is set to [−90°, −30°, 0°, 30°, 90°], the corresponding u shall become [−1, ¼, 0, ½, 1]. The difference in the “u” coordinate for the beam pointing directions between adjacent scanned beams generated by the array with the BFN 2410, or Δu, is ½. Since the element spacing among the 4 elements 2420 of the array is set at a half wavelength, the grating lobes will appear at directions with Δu=2. The grating lobes for beams pointed at various direction, their respective grating lobes are in imaginary space. Only beams pointed near end-fired directions θ=±90° as Beam 3 in FIG. 25.

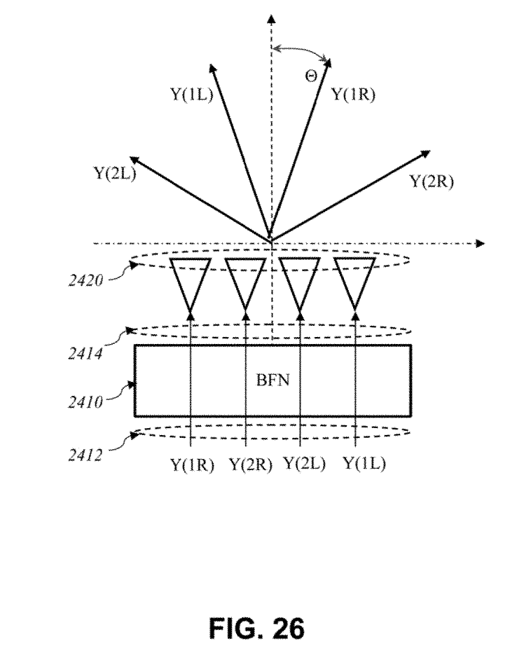

FIG. 26 is a diagram illustrating geometry of an array forming multiple beams via Butler matrices according to one embodiment.

For an array forming multiple beams via Butler Matrixes, the corresponding geometries are shown in FIG. 26. The transmitting linear array features 4 radiating elements 2420 with a uniform spacing of half wavelength. The beam forming network 2410, implemented by a 4-to-4 Butler Matrix or programmed in software in a digital beam forming (DBF) network to function as a Butler matrix, features 4 inputs 2412 and 4 outputs 2414. A first input is fed by a stream of data of Y(1R). Similarly, a 2^{nd}, a 3^{rd}, and a 4^{th} inputs are, respectively connected to 3 other data streams indicated as Y(2R), Y(2L), and Y(1L). These 4 streams of data are radiated concurrently from all 4 elements 2420 of the transmitting array.

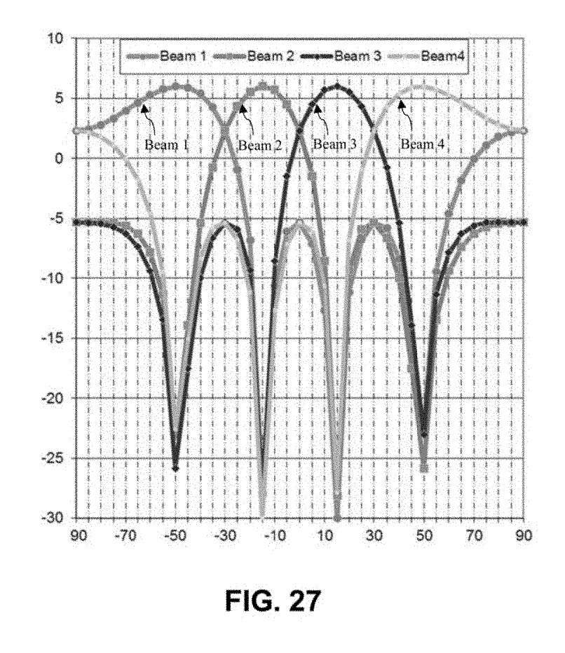

FIG. 27 is a diagram illustrating a corresponding far field radiation patterns according to one embodiment.

The four beams feature OB radiation patterns; and 4 peaks at ±14.48°, and ±48.59°. The corresponding u shall become [¾, −¼, ¼, ¾]. The spacing in u between the pointing directions of two adjacent beams or Δu, is also ½; identical to that among the 4 OB radiation patterns from the configuration in FIG. 24. In fact, the 4 OB radiation patterns in FIG. 24 and those in FIG. 26 shall be identical if an additional phase gradient of π/4 among the 4 element 2420 after the 4-to-4 FFT is implemented. As a result, the four OB beams shall be biased or rotated in pointing directions by a δu where δu=−¼. More specifically, Y(1) shall be pointed from the original direction u=0 to a new direction u=−¼ or 0° to −14.48°. The beam pointing direction for Y(j) stream shall be rotated from u=−½ (or −30° from the boresight) to u=−¾ (or −48.59° from the boresight), and that for the beam pointing direction for Y(−1) stream shall be rotated from u=±1 (or ±90° from the boresight, or the end-fired directions) to u=¾ (or 48.59° from the boresight). The beam pointing direction for Y(j) stream shall be rotated from u=½ (or 30° from the boresight) to u=¼ (or 14.48° from the boresight). The OB pattern features among the 4 beams in the new pointing directions shall remain true.

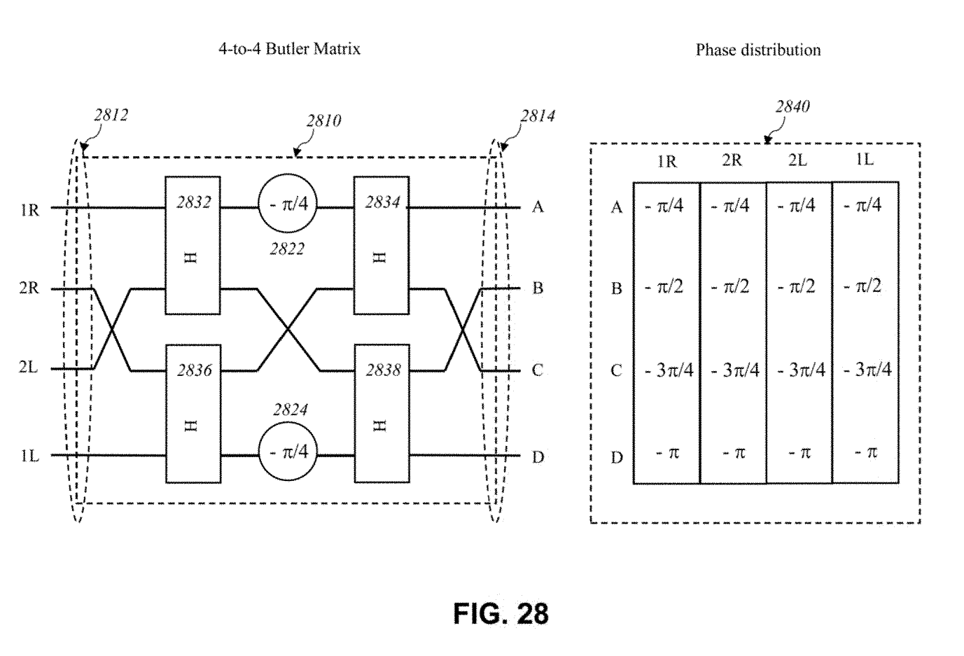

FIG. 28 is a diagram illustrating a functional diagram of a 4-to-4 Butler matrix according to one embodiment.

The Butler matrices are linear devices. Therefore, superposition principle is applicable for both the homogeneity and additivity properties. FIG. 28 depicts a functional diagram of a 4-to-4 Butler Matrix 2810, featuring 4 inputs 2812 and 4 outputs 2814. The 4 inputs are labeled as 1R, 2R, 2L and 1L; and the 4 outputs are A, B, C and D. The 4-to-4 Butler Matrix 2810 comprises four 90° hybrids 2832, 2834, 2836, and 2838 and two 45° fixed phase shifters 2822 and 2824.

The 4 inputs 2812 can be connected to 4 independent data flows. A first input stream connected to the 1R port will appear in all 4 output ports [A, B, C, D] featuring a unique phase progression with a phase difference Δφ of −45° or −π/4 among adjacent ports. The unique phase progression is referred to a wavefront; mathematically expressed in similar forms of equations (21-1) to (21-4). Similarly, a second input stream connected to the 2R port will appear in all 4 output ports [A, B, C, D] featuring a unique phase progression with a phase difference Δφ of −135° or −π/4 among adjacent ports. A third input stream connected to the 2L port will appear in all 4 output ports [A, B, C, D] featuring a unique phase progression with a phase difference Δφ of 135° or π/4 among adjacent ports. A fourth input stream connected to the 1L port will appear in all 4 output ports [A, B, C, D] featuring a unique phase progression with a phase difference Δφ of 45° or π/4 among adjacent ports. The phase distributions of the outputs 2814 according to ports of the inputs 2812 are summarized in Table 3. Each input port of the 4 inputs 2812 is associated with a unique wavefront. There are 4 wavefronts generated by the 4-to-4 Butler matrix, and they are orthogonal to one another.

TABLE 3

| | A | B | C | D | Δφ |
|---|---|---|---|---|---|
| 1R | −π/4 | −π/2 | −3π/4 | −π | −π/4 |
| 2R | −π/2 | −5π/4 | 0 | −3π/4 | −3π/4 |
| 2L | −3π/4 | 0 | −5π/4 | −π/2 | 3π/4 |
| 1L | −π | −3π/4 | −π/2 | −π/4 | π/4 |

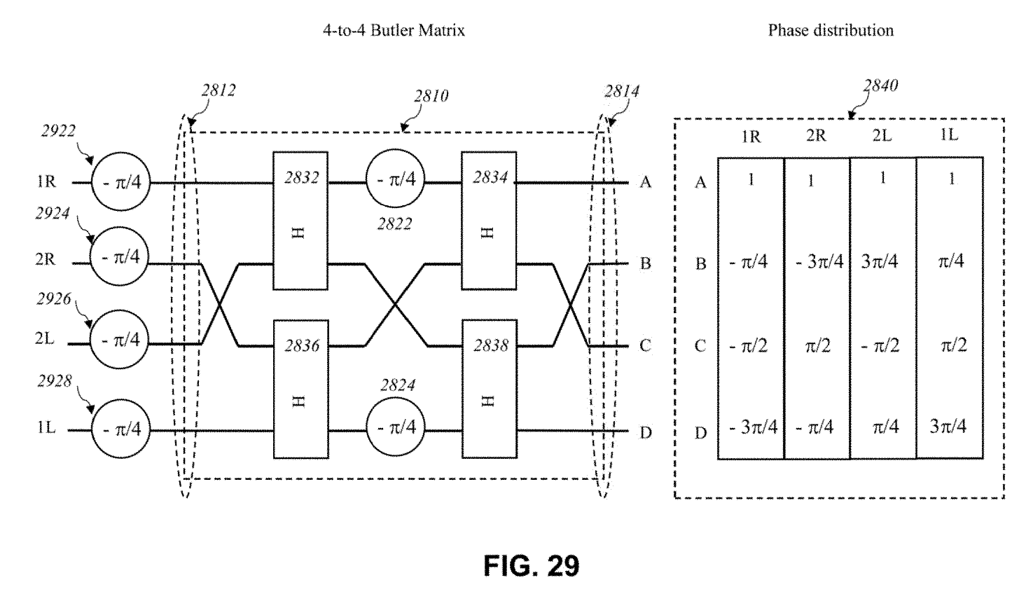

FIG. 29 is a diagram illustrating a functional diagram of a 4-to-4 Butler matrix with phase biasing according to one embodiment.

When we add a section of phase biasing 2922 to 2928 in front the 4 inputs 2812 of the 4-to-4 Butler matrix 2810 as shown in FIG. 29, the new phase distribution is depicted in Table-4. A phase reference, port A of the 4 outputs 2814, is used. However, the phase progressions or Δφ among the 4 outputs 1404 for each of the 4 inputs 2812 remain identical to those in Table-3.

TABLE 4

| | A | B | C | D | Δφ |
|---|---|---|---|---|---|
| 1R | 1 | −π/4 | −2π/4 | −3π/4 | −π/4 |
| 2R | 1 | −3π/4 | π/2 | −π/4 | −3π/4 |
| 2L | 1 | 3π/4 | −2π/4 | π/4 | 3π/4 |
| 1L | 1 | π/4 | π/2 | 3π/4 | π/4 |

The pointing directions in FIG. 24 and those in FIG. 26 will become identical if an additional phase gradient of π/4 among the 4 element 2420 after the 4-to-4 FFT in FIG. 24 is implemented. As a result, the four OB beams in FIG. 24 shall be biased or rotated in pointing directions by a δu where δu=−¼. More specifically, Y(1) shall be pointed from the original direction u=0 to a new direction u=−¼ or 0° to −14.48°. The beam pointing direction for Y(j) stream shall be rotated from u=−½ (or −30° from the boresight) to u=−¾ (or −48.59° from the boresight), and that for the beam pointing direction for Y(−1) stream shall be rotated from u=±1 (or ±90° from the boresight, or the end-fired directions) to u=¾ (or 48.59° from the boresight).

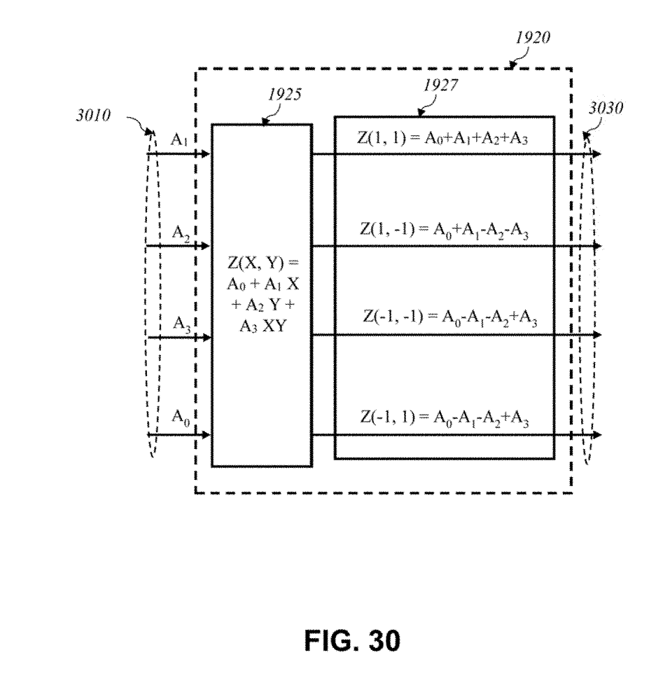

FIG. 30 is a diagram illustrating an erasure code (EC) polynomial for K muxing function according to one embodiment.

In many other embodiments, the EC polynomial can be programmed to functions as other K-muxing transforms. FIG. 30 depicts another example of using EC polynomial 1925 for K-muxing function. It is a 4-to-4 K-muxing 1910 with 4 real inputs 3010 and 4 real outputs 3030. The polynomial chosen is a two-dimensional one; as written in Equation (29), and the 4 sampling points for four outputs are (1, 1), (1, −1), (−1, −1), and (−1, 1) in a XY plane

Z(X, Y)=A₀+A₁X+A₂Y+A₃XY (29)

or

Z₁=Z(1, 1)=A₀+A₁+A₂+A₃ (30-1)

Z₂=Z(−1, 1)=A₀−A₁+A₂−A₃ (30-2)

Z₃=Z(−1, −1)=A₀−A₁−A₂+A₃ (30-3)

Z₄=Z(1, −1)=A₀+A₁−A₂−A₃ (30-4)

These equations between the 4 inputs [As] and the 4 outputs [Z] can be written in a matrix form;

$$\begin{matrix}[ Z ] = [ H ] * [ As ] \\ where & ( 31 ) \\ [ Z ] = {[ {Z}_{1} , {Z}_{2} , {Z}_{3} , {Z}_{4} ]}^{T} & ( 32 ) \\ [ As ] = [ {A}_{0} , {A}_{1} , {A}_{2} , {A}_{3} ] & ( 33 ) \\ [ H ] = [ \begin{matrix}1 & 1 & 1 & 1 \\ 1 & - 1 & 1 & - 1 \\ 1 & - 1 & - 1 & 1 \\ 1 & 1 & - 1 & - 1\end{matrix} ] \\ [ H ] is a 4 \text{-} to \text{-} 4 Hadamard matrix … & ( 34 )\end{matrix}$$

It is clear that the EC polynomial 1925 can be programmed to functions as a Hadamard transform for K-muxing 1910.

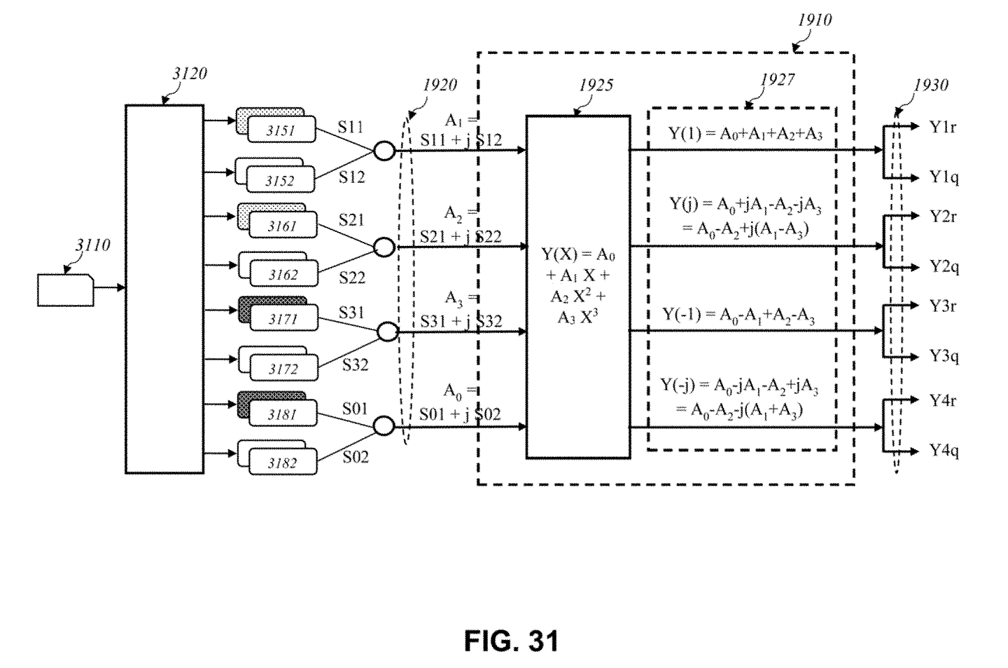

FIG. 31 is a diagram illustrating a processing device using a polynomial for generating Reed-Solomon (RS) code as a K muxing process with multiple media record files according to one embodiment.

FIG. 31 depicts the same block diagram as that of FIG. 19, except the inputs 1920 are connected to medical records 3110 of patients instead of digital photos. The medical record 3110 includes personal data and information associated with personal data. Storage via conventional K-muxing features privacy and redundancy. The medical record 3110 can be sorted out into multiple categories through a sorting process 3120. In this example, assume the medical records 3110 are sorted and grouped into 8 folders; from S11 3151 to S02 3182. Two of them S11 3151 and S21 3161 are personal data. In addition, S31 3171 and S01 3181 may be key information associated to personal data. The remaining four files S12 3152, S22 3162, S32 3172, and S02 3182 belong to a category of public information.

FIG. 31 depicts a block diagram using a polynomial 1925 for RS code, as a version K-muxing 1910 among medical records. The polynomial 1925 is sampled at multiple Xs on a unity circle in a complex X-plane, where the amplitudes of the sampled X's always equal to unity.

Y(X)=A₀+A₁X+A₂X²+A₃X³ (17)

where the complex input [A₀] comprising inputs for digital data of S01 3181 and S02 3182 which are converted as a stream S01+j S02, the complex input [A₁] comprising inputs for digital data of S11 3151 and S12 3152 which are converted as a stream S11+j S12, the complex input [A2] comprising inputs for digital data of S21 3161 and S22 3162 which are converted as a stream S21+j S22, the complex input [A3] comprising inputs for digital data of S31 3171 and S32 3172 which are converted as a stream S31+j 532,[A₀, A₁, A₂, A₃] are the 4 inputs 1920 of a K-muxing 1910.

We will program the polynomial 1925 to function as 4-to-4 FFT. Corresponding 4 complex outputs 1930 of the K-muxing 1910 comprise the following 8 aggregated real number data flows;

Y1r=S01+S11+S21+S31 (23-1)

Y1q=S02+S12+S22+S32 (23-2)

Y2r=S01−S12−S21+S32 (23-3)

Y2q=S02+S11−S22−S31 (23-4)

Y3r=S01−S11+S21−S31 (23-5)

Y3q=S02−S12+S22−S32 (23-6)

Y4r=S01+S12−S21−S32 (23-7)

Y4q=S02+S11−S22−S31 (23-8)

Assuming any one of the 8 real inputs is unavailable, we only need 4 stored files for local repairs.

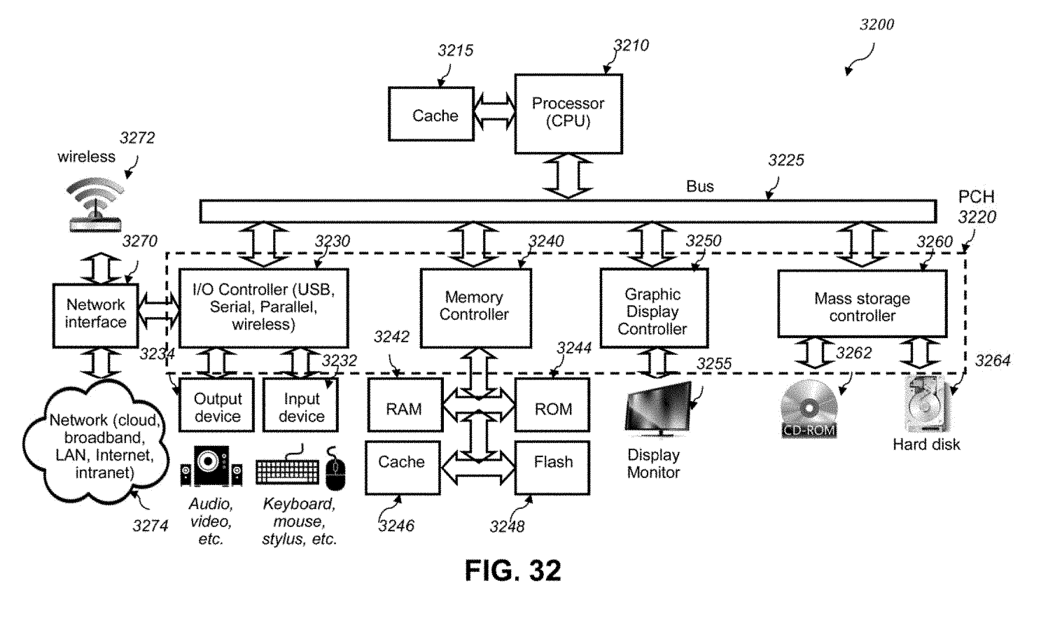

FIG. 32 is a diagram illustrating a processing system 3200 according to one embodiment. The system 3200 represents a computing device that performs the functionalities described above. For example, the system 3200 may represent the computing device 110, the mobile device 805 or 905. It may perform the functionalities 140 (in FIG. 1 and 4) or 540 (in FIG. 5), etc.

The system 3200 includes a central processing unit (CPU) or a processor 3210, a cache 3215, a platform controller hub (PCH) 3220, and a bus 3225. The PCH 3220 may include an input/output (I/0) controller 3230, a memory controller 3240, a graphic display controller (GDC) 3250, and a mass storage controller 3260. The system 3200 may include more or less than the above components. For mobile devices, the system 3200 includes only the basic elements and may not include bulky devices such as hard drive, etc. In addition, a component may be integrated into another component. As shown in FIG. 32, all the controllers 3230, 3240, 3250, and 3260 are integrated in the PCH 3220. The integration may be partial and/or overlapped. For example, the GDC 3250 may be integrated into the CPU 3210, the I/0 controller 3230 and the memory controller 3240 may be integrated into one single controller, etc.

The CPU or processor 3210 is a programmable device that may execute a program or a collection of instructions to carry out a task. It may be a general-purpose processor, a digital signal processor, a microcontroller, or a specially designed processor such as one design from Applications Specific Integrated Circuit (ASIC). It may include a single core or multiple cores. Each core may have multi-way multi-threading. The CPU 3210 may have simultaneous multithreading feature to further exploit the parallelism due to multiple threads across the multiple cores. In addition, the CPU 3210 may have internal caches at multiple levels.

The cache 3215 is a first level (L1) external cache memory. It is typically implemented by fast static random access memory (RAM). Other cache levels may appear externally, such as the cache 3246. Some or all cache levels (L1, L2, and L3) may all be integrated inside the CPU 3210.

The bus 3225 may be any suitable bus connecting the CPU 3210 to other devices, including the PCH 3220. For example, the bus 3225 may be a Direct Media Interface (DMI).

The PCH 3220 in a highly integrated chipset that includes many functionalities to provide interface to several devices such as memory devices, input/output devices, storage devices, network devices, etc.

The I/O controller 3230 controls input devices (e.g., stylus, keyboard, and mouse, microphone, image sensor) and output devices (e.g., audio devices, speaker, scanner, printer). It also has interface to a network interface card 3270 which provides interface to a network 3274 and wireless controller 3272. The network 3274 may represent the network 120 shown in FIG. 1. The network interface card (NIC) 3270 transmits and receives the data packets to and from a wired, wireless network 3272 or 3274. The NIC 3270 may have one or more sockets for network cables and the type of socket depends on the type of network it will be used in. The network 3274 may be a LAN, a MAN, a WAN, an intranet, an extranet, or the Internet.

The memory controller 3240 controls memory devices such as the random access memory (RAM) 3242, the read-only memory (ROM) 3244, the cache memory 3246, and the flash memory 3248. The RAM 3242 may store instructions or programs, loaded from a mass storage device, that, when executed by the CPU 3210, cause the CPU 3210 to perform operations as described above, such as WFM (K-muxing) or WFD (K-de-muxing) operations. It may also store data used in the operations, including the input data stream or the output data stream. The ROM 3244 may include instructions, programs, constants, or data that are maintained whether it is powered or not. This may include the matrix coefficients used in the K-muxing or K-demuxing process, a boot program, self-test programs, etc. The cache memory 3246 may store cache data at level L2 or L3. The cache memory 3246 is typically implemented by fast static RAM to allow fast access from the CPU 3210. The flash memory 3248 may store programs, instructions, constants, tables, coefficients, envelopes as in the ROM 3244. It may be erased and programmed as necessary.

The GDC 3250 controls the display monitor 3255 and provides graphical operations. It may be integrated inside the CPU 3210. It typically has a graphical user interface (GUI) to allow interactions with a user who may send a command or activate a function.

The mass storage controller 3260 controls the mass storage devices such as CD-ROM 3262 and hard disk 3264.

Additional devices or bus interfaces may be available for interconnections and/or expansion. Some examples may include the Peripheral Component Interconnect Express (PCIe) bus, the Universal Serial Bus (USB), etc.

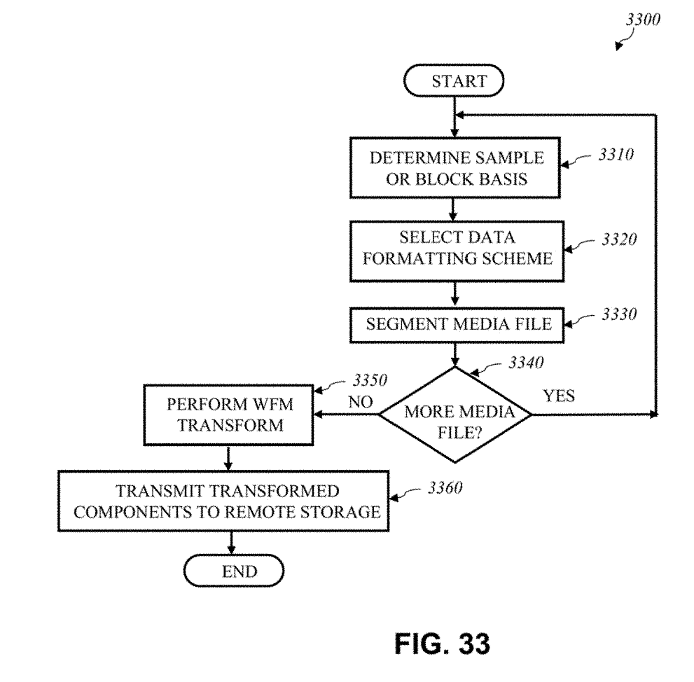

FIG. 33 is a flowchart illustrating a process 3300 for K muxing according to one embodiment.

Upon START, the process 3300 determines whether a sample basis or a block basis is desired (Block 3310). Then, the process 3300 selects a data formatting scheme according to the desired basis, sample or block (Block 3320). This data formatting scheme is known by a recovery process that recovers the original data.

Next, the process 3300 segments the media file input in accordance to the selected data formatting scheme (Block 3330). The media file input is segmented into N media components. Then, the process 3300 determines if more media files are needed (Block 3340). If so, the process 3300 returns to block 3310. Otherwise, the process 3300 performs the WFM transform on the N media components (Block 3350). Each of the N transfomed components is a linear combination of the N media components. Next, the process 3300 transmits the transformed components to the remote or network storages (Block 3360). The remote or network storage may include network-attached storages or cloud storages. The process 3300 is then terminated.

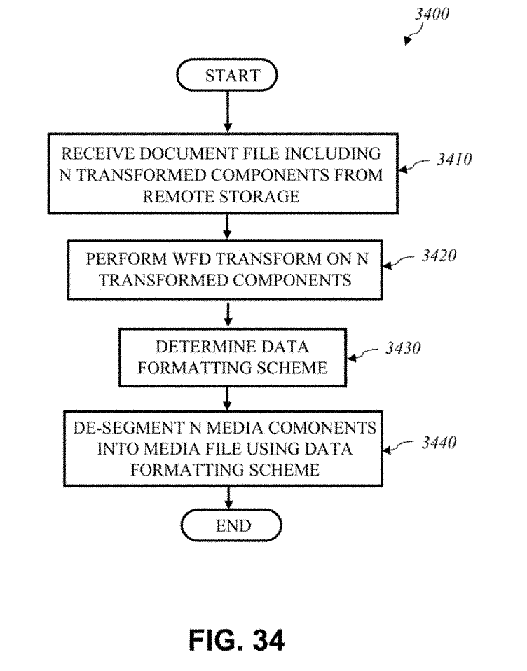

FIG. 34 is a flowchart illustrating a process 3400 for K de-muxing according to one embodiment.

Upon START, the process 3400 receives a document file or document files from a remote or network storage (Block 3410). The document file includes N transformed components. Next, the process 3400 performs a WFD transform on the N transformed components (Block 3420). The WFD transform transforms the N transformed components into N media components on a sample basis or a block basis according to a data formatting scheme. Each of the N media components is a linear combination of the N transformed components.

Then, the process 3400 determines the data formatting scheme (Block 3430). The data formatting scheme is the scheme that is used to pre-process the document file prior to storing the document file in the remote or network storage. Next, the process 3400 de-segments the N media components into the media file using the data formatting scheme (Block 3440). The process 3400 is then terminated.

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EROM). Examples of firmware may include microcode, writable control store, micro-programmed structure.

When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any non-transitory medium that may store information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus comprising:
a segmenter to segment a media file or a plurality of media files into N media components using a data formatting scheme;
a wavefront multiplexing (WFM) processor to transform the N media components to N transformed components on a sample basis or a block basis according to the data formatting scheme, each of the N transformed components being a linear combination of the N media components; and
a network interface to transmit the N transformed components to a server for storage as a document file on a remote storage via a network connectivity.

2. The apparatus according to claim 1 wherein the media file includes an image, an image sequence, an audio clip, a video clip, or an audio-visual clip.

3. The apparatus according to claim 1 wherein the plurality of media files includes any combination of at least an image, an image sequence, an audio clip, a video clip, or an audio-visual clip.

4. The apparatus according to claim 1 wherein the data formatting scheme is known by a recovery device that recovers the media file or a plurality of media files from the N transformed components stored in the network storage.

5. The apparatus according to claim 1 wherein the data formatting scheme selects, from the media file or one of the plurality of media files, samples or blocks of samples on the sample basis or the block basis, respectively.

6. The apparatus according to claim 1 wherein the data formatting scheme includes a combination, a random or non-random permutation, or an arrangement.

7. The apparatus according to claim 1 wherein the remote storage includes a network-attached storage or a cloud storage.

8. The apparatus according to claim 1 wherein the WVF processor comprises:
an adder to compute a sum of the N media components weighted by corresponding weights to generate the N transformed components.

9. The apparatus according to claim 1 wherein the corresponding weights form an orthogonal matrix.

10. The apparatus according to claim 1 wherein the WVF processor further comprises:
a multiplier to multiply the N media components with corresponding weights to generate the weighted N media components.

11. An apparatus comprising:
a network interface to receive a document file including N transformed components from a remote storage via a network connectivity;
a wavefront de-multiplexing (WFD) processor to transform the N transformed components to N media components on a sample basis or a block basis according to a data formatting scheme, each of the N media components being a linear combination of the N transformed components; and
a de-segmenter to de-segment the N media components into a media file or a plurality of media files using the data formatting scheme.

12. The apparatus according to claim 11 wherein the media file includes an image, an image sequence, an audio clip, a video clip, or an audio-visual clip.

13. The apparatus according to claim 11 wherein the plurality of media files includes any combination of at least an image, an image sequence, an audio clip, a video clip, or an audio-visual clip.

14. The apparatus according to claim 11 wherein the data formatting scheme is used by a pre-processing device that processes the media file or the plurality of media files to generate the N transformed components stored in the network storage.

15. The apparatus according to claim 11 wherein the data formatting scheme selects, from the media file or one of the plurality of media files, samples or blocks of samples on the sample basis or the block basis, respectively.

16. The apparatus according to claim 11 wherein the data formatting scheme includes a combination, a random or non-random permutation, or an arrangement.

17. The apparatus according to claim 11 wherein the remote storage includes a network-attached storage or a cloud storage.

18. The apparatus according to claim 11 wherein the WFD processor comprises:
an adder to compute a sum of the N transformed components weighted by corresponding weights to generate the N media components.

19. The apparatus according to claim 11 wherein the corresponding weights form an orthogonal matrix.

20. The apparatus according to claim 11 wherein the WFD processor further comprises:
a multiplier to multiply the N transformed media components with the corresponding weights to generate the weighted N transformed components.
